(19) United States
(12) Patent Application Publication
(10) Pub. No.: US 2021/0195904 A1
(43) Pub. Date: Jul. 1, 2021

(54) METHOD FOR MANUFACTURING MODIFIED GLUTEN

(71) Applicant: MITSUBISHI CORPORATION LIFE SCIENCES LIMITED, Tokyo (JP)

(72) Inventors: Keisuke TAKAHASHI, Ibaraki (JP); Tadayoshi KATSUMATA, Ibaraki (JP); Akihito FUJIMOTO, Ibaraki (JP)

(73) Assignee: MITSUBISHI CORPORATION LIFE SCIENCES LIMITED, Tokyo (JP)

(21) Appl. No.: 17/201,378

(22) Filed: Mar. 15, 2021

Related U.S. Application Data
(62) Division of application No. 15/999,832, filed on Aug. 20, 2018.

(30) Foreign Application Priority Data
Feb. 19, 2016 (JP) 2016-030457

(51) Int. Cl. A21D 2/26; A21D 13/064; A23J 3/18; A23J 3/24; A21D 13/06

(52) U.S. Cl. CPC A21D 2/265; A21D 13/064; A23J 3/18; A23V 2200/242; A21D 13/06; A21D 2/26; A23V 2002/00; A23J 3/24

(57) ABSTRACT

A method for manufacturing a bread dough that includes preparing a bread dough using modified gluten obtained by heating a solution containing gluten and an organic acid having two or more carbonyl groups in the same molecule at 1 part by weight or more per 100 parts by weight of the gluten at 70° C. or higher for 30 minutes or longer.

### CROSS-REFERENCE TO RELATED APPLICATIONS

This is a divisional application of U.S. patent application Ser. No. 15/999,832, filed on Aug. 20, 2018, which is a U.S National Phase of International Patent Application No. PCT/JP2017/003542, filed on Feb. 1, 2017 which claims priority to Japanese Patent Application No. 2016-030457, filed on Feb. 19, 2016. The disclosure of each of these applications is herein incorporated by reference in its entirety.

### TECHNICAL FIELD

The present invention relates to modified gluten which can impart excellent freezing tolerance to a food dough, particularly a bread dough, a method for manufacturing the modified gluten, and utilization of the modified gluten.

### BACKGROUND ART

In recent bread industry, various dough modifying agents have been proposed, and for example, there are those that improve the mouthfeel, those that impart mechanical tolerance, and those that impart freezing tolerance by modifying the physical properties of dough. Gluten, which is one kind of protein that can be obtained from wheat, rye and the like, exhibits both flexibility and viscoelasticity, and the amount and structure thereof are important factors to determine the shape, volume and mouthfeel of bread. Hence, enhancement of the gluten strength of wheat flour or the like itself is one means for modifying the physical properties of dough, and specifically, the enhancement is performed by adding vitamin C (L-ascorbic acid) and a salt to the dough and the raw materials for dough, adjusting the water content and pH of the dough, adjusting the sugar content and the amount of fat and oil in the dough, and the like.

However, there is a case in which the above methods are hardly effective depending on the amount of gluten in wheat flour and the like, and there is also a method in which the gluten strength is enhanced by the addition of gluten itself separately from the wheat flour and the like. In addition, a method in which the effect is increased by modifying the gluten itself to be added has been hitherto investigated. For example, Patent Literature 1 discloses a method for manufacturing a modified substance of gluten exhibiting water absorbability and emulsifiability by preparing a gluten dispersion by adding gluten to an acidic aqueous solution and subjecting the gluten dispersion to a heat treatment, and it is stated that bread produced by adding the modified substance of gluten prepared using an aqueous solution of lactic acid to the dough exhibits excellent extensibility and soft mouthfeel. In addition, Patent Literature 2 discloses a method for manufacturing a modified gluten powder by obtaining an aggregate with gluten by adding a thickening agent having an electric charge to an acidic dispersion liquid of gluten having a pH higher than 2.0 and lower than 5.0 and then drying and pulverizing the aggregate, and it is stated that elastic mouthfeel can be retained even at a low pH when the modified gluten powder is used in bread and noodles. In addition, Patent Literature 3 discloses a method for manufacturing a dry powder of gluten exhibiting high processing characteristics by subjecting one in which gluten is dispersed in an acidic solution having a pH of 2.0 to 6.0 to a heat denaturation treatment at 60° C. to 160° C. and then drying the resultant. However, in any of these literatures, the freezing tolerance of bread dough and the firmness of bread after being baked are not investigated. In addition, it is stated that the acid to be used for preparing the acidic aqueous solution to which gluten is added is not limited as long as it can be adjusted to a predetermined pH, and organic acids or inorganic acids can be widely used (for example, paragraph 0025 in Patent Literature 1 and paragraph 0020 in Patent Literature 2).

Bread is generally manufactured through steps such as preparation, mixing, dividing, bench time, molding, proofing, and baking. A frozen bread dough is used when the dough is deep-frozen in the course of this bread making process to once discontinue the manufacture, then thawed, subjected to the final fermentation, and then baked, and it is possible to greatly improve the working efficiency by using a frozen bread dough. However, the gluten network in the dough is destroyed due to the growth of ice crystals during the deep freeze and the like and the dough is weakened, and the frozen bread dough is not sufficiently leavened in the final fermentation, and there is thus a problem that the height and bulge of bread after being baked are insufficient and the appearance, mouthfeel and the like are inferior to those of bread which has been subjected to a so-called scratch method without involving deep freeze.

As a means for improving the of such a dough, it has been practiced to improve the properties of gluten and to impart freezing tolerance to the dough by oxidizing the thiol group in gluten using an oxidizing agent such as L-ascorbic acid and promoting the formation of disulfide bond. However, it is known that the mechanical tolerance when subjecting the dough to a packaging machine and the like decreases since the dough is tightened and the elongation becomes poor in a case in which L-ascorbic acid is added to the raw material for dough in an amount enough to produce the effect of freezing tolerance (Patent Literature 4 and Non Patent Literature 1).

### CITATION LIST

### Patent Literature

Patent Literature 1: JP 2014-198037 A
Patent Literature 2: JP 4168102 B2
Patent Literature 3: JP 52-24579 B
Patent Literature 4: JP 63-079552 A

### Non Patent Literature

Non Patent Literature 1: Kyoto Women's University Journal of Food Sciences 18 (1966), 1-5

### SUMMARY OF INVENTION

### Technical Problem

An object of the present invention is to provide modified gluten which can impart excellent freezing tolerance to a bread dough and a method for manufacturing the modified gluten.

### Solution to Problem

The present invention relates to the following (1) to (7).

(1) A method for manufacturing modified gluten, the method including: a step of heating a solution containing gluten and an organic acid having two or more carbonyl groups in the same molecule at 1 part by weight or more per 100 parts by weight of the gluten at 70° C. or higher for 30 minutes or longer.

(2) A method for manufacturing a bread dough, the method including: a step of preparing a bread dough using modified gluten obtained by heating a solution containing gluten and an organic acid having two or more carbonyl groups in the same molecule at 1 part by weight or more per 100 parts by weight of the gluten at 70° C. or higher for 30 minutes or longer.

(3) A method for manufacturing bread, the method including: a step of preparing a bread dough using modified gluten obtained by heating a solution containing gluten and an organic acid having two or more carbonyl groups in the same molecule at 1 part by weight or more per 100 parts by weight of the gluten at 70° C. or higher for 30 minutes or longer; and a step of baking the bread dough prepared.

(4) A method for modifying physical properties of bread, the method including: adding modified gluten obtained by heating a solution containing gluten and an organic acid having two or more carbonyl groups in the same molecule at 1 part by weight or more per 100 parts by weight of the gluten at 70° C. or higher for 30 minutes or longer to a raw material for bread dough.

(5) The method according to (4), wherein modification in physical properties of bread is improvement in firmness of bread.

(6) The method according to any one of (2) to (4), wherein the bread dough is a frozen bread dough.

(7) Modified gluten obtained by heating a solution containing gluten and an organic acid having two or more carbonyl groups in the same molecule at 1 part by weight or more per 100 parts by weight of the gluten at 70° C. or higher for 30 minutes or longer.

This application is based upon and claims the benefit of priority of the prior Japanese Patent Application No. 2016-030457 filed on Feb. 19, 2016 and encompasses the contents described in the specification of the patent application.

### Advantageous Effects of Invention

According to the present invention, there are provided modified gluten which can impart excellent freezing tolerance to a food dough, particularly a bread dough and a method for manufacturing the modified gluten. By adding the modified gluten of the present invention to a bread dough, degradation of the gluten network due to deep freeze is suppressed and bread which is voluminous and has a shape with favorable firmness is obtained. In addition, by adding the modified gluten of the present invention to a bread dough, it is possible to increase the amount of water absorbed and thus to achieve cost reduction and mouthfeel improving effects. In addition, the elasticity of the dough to which freezing tolerance is imparted by the addition of L-ascorbic acid is too strong, and thus a molding error, unwinding of a “roll” of the molded dough is likely to occur, for example, in roll bread, but the modified gluten of the present invention imparts freezing tolerance to the dough and, at the same time, favorably maintains the extensibility and elasticity of the dough. Furthermore, by using the modified gluten of the present invention, it is possible to produce a frozen dough exhibiting freezing tolerance even without adjusting the water content to be different from that of a dough for the scratch method (a method in which mixing to baking are straightly performed/straight mixing method) in which ordinary deep freeze is not performed at the time of manufacture and thus to manufacture the dough for the scratch method and the dough for a frozen dough on the same production line by the same prescription without distinguishing these from each other, and as a result, the work efficiency and productivity are improved.

### BRIEF DESCRIPTION OF DRAWINGS

FIG. 1 illustrates the appearance of baked roll bread obtained by deep-freezing the respective doughs of Invention Product A (Powder A: using gluten treated with succinic acid), Invention Product B (Powder B: using gluten treated with malic acid), Invention Product C (powder C: using gluten treated with citric acid), Additive-free Product, and Comparative Product 1 (using untreated gluten) for 14 days and then baking these doughs.

FIG. 2 illustrates the appearance of baked roll bread obtained by deep-freezing the respective doughs of Invention Product D (Powder D: using gluten treated with malonic acid), Invention Product E (Powder E: using gluten treated with succinic acid), Invention Product F (Powder F: using gluten treated with glutaric acid), Invention Product G (Powder G: using gluten treated with adipic acid), and Comparative Product 2 (using untreated gluten) for 30 days and then baking these doughs.

FIG. 3 illustrates the appearance of baked roll bread obtained by deep-freezing the respective doughs of Invention Product H (Powder H: using gluten treated with 2.00 g of succinic acid), Invention Product I (Powder I: using gluten treated with 4.00 g of succinic acid), Invention Product J (Powder J: using gluten treated with 6.00 g of succinic acid), Invention Product K (Powder K: using gluten treated with 8.00 g of succinic acid), Invention Product L (Powder L: using gluten treated with 10.00 g of succinic acid), and Comparative Product 3 (using untreated gluten) for 30 days and then baking these doughs.

FIG. 4 illustrates the appearance of baked roll bread obtained by deep-freezing the respective doughs of Invention Product M (Powder M: using gluten treated with succinic acid at 70° C.), Invention Product N (Powder N: using gluten treated with succinic acid at 80° C.), Invention Product O (Powder O: using gluten treated with succinic acid at 90° C.), and Comparative Product 4 (using untreated gluten) for 30 days and then baking these doughs.

FIG. 5 illustrates the appearance of baked roll bread obtained by deep-freezing the respective doughs of Comparative Product Q (Powder Q: using gluten treated with succinic acid at 50° C.), Comparative Product R (Powder R: using gluten treated with succinic acid at 60° C.), Invention Product S (Powder S: using gluten treated with succinic acid at 70° C.), and Comparative Product 5 (using untreated gluten) for 30 days and then baking these doughs.

FIG. 6 illustrates the appearance of baked roll bread obtained by deep-freezing the respective doughs of Invention Product T (Powder T: using gluten treated with succinic acid at 80° C. for 30 minutes), Invention Product U (Powder U: using gluten treated with succinic acid at 80° C. for 60 minutes), Invention Product V (Powder V: using gluten treated with succinic acid at 80° C. for 300 minutes), and Comparative Product 6 (using untreated gluten) for 14 days and then baking these doughs.

FIG. 7 illustrates the appearance of baked roll bread obtained by deep-freezing the respective doughs of Invention Product W (Powder W: using gluten treated with succinic acid at 70° C. for 90 minutes), Invention Product X (Powder X: using gluten treated with succinic acid at 70° C. for 180 minutes), Invention Product Y (Powder Y: using gluten treated with succinic acid at 70° C. for 300 minutes), and Comparative Product 7 (using untreated gluten) for 14 days and then baking these doughs.

FIG. 8 illustrates the appearance of baked roll bread obtained by deep-freezing the respective doughs of Invention Product FD (Powder FD: using freeze-dried dry powder), Invention Product DD (Powder DD: using drum-dried dry powder), Invention Product SD (Powder SD; using spray-dried dry powder), and Comparative Product 8 (using untreated gluten) for 30 days and then baking these doughs.

FIG. 9 illustrates the appearance of baked roll bread obtained by deep-freezing the respective doughs of Invention Products FD65, FD70, and FD75 in which Powder FD is used and the amount of water added is changed and Comparative Products 9A to 9C (using untreated gluten) for 7 days and then baking these doughs.

FIG. 10 illustrates the appearance of baked roll bread obtained by deep-freezing the respective doughs of Invention Product AA00 section, Invention Product AA10, Invention Product AA50, and Invention Product AA100 in which Powder FD is used and the amount of L-ascorbic acid is changed, for 30 days, and then baking these doughs.

FIG. 11 illustrates the appearance of baked roll bread obtained by deep-freezing the respective doughs of Comparative Product PT (Comparative Powder PT: using gluten treated with putrescine), Comparative Product CV (Comparative Powder CV: using gluten treated with cadaverine), and Comparative Product 10 (using untreated gluten) for 30 days and then baking these doughs.

FIG. 12 illustrates the appearance of baked roll bread obtained by deep-freezing the respective doughs of Comparative Product SA (Comparative Powder SA: using gluten treated with acetic acid), Comparative Product HA (Comparative Powder HA: using gluten treated with hydrochloric acid), and Comparative Product 11 (using untreated gluten) for 30 days and then baking these doughs.

FIG. 13 illustrates the appearance of baked roll bread obtained by deep-freezing the respective doughs of Invention Product 121 (Powder 121: using gluten treated with 4.00 g of succinic acid), Invention Product 122 (Powder 122: using gluten treated with 2.00 g of succinic acid and 2.00 g of citric acid), Invention Product 123 (Powder 123: using gluten treated with 2.00 g of succinic acid and 2.00 g of malic acid), and Invention Product 124 (Powder 124: using gluten treated with 2.00 g of citric acid and 2.00 g of malic acid) for 30 days and then baking these doughs.

FIG. 14 illustrates the appearance of baked roll bread obtained by deep-freezing the respective doughs of Comparative Product 130 (using vital gluten before being reacted), Comparative Product 131 (Powder 131: using gluten treated with 0.50 g of succinic acid), Comparative Product 132 (Powder 132: using gluten treated with 1.00 g of succinic acid), and Comparative Product 133 (Powder 133: using gluten treated with 2.00 g of succinic acid) for 30 days and then baking these doughs.

FIG. 15 illustrates the reference diagram for the measurement of firmness of bread (a: the portion having the widest width of bread, and γ: the widest width of the surface in contact with the top plate of bread).

### DESCRIPTION OF EMBODIMENTS

The present invention is a method for manufacturing modified gluten, which includes a step of heating a solution containing gluten and an organic acid having two or more carbonyl groups in the same molecule at 1 part by weight or more per 100 parts by weight of the gluten at 70° C. or higher for 30 minutes or longer. The present invention is also modified gluten obtained by heating a solution containing gluten and an organic acid having two or more carbonyl groups in the same molecule at 1 part by weight or more per 100 parts by weight of the gluten at 70° C. or higher for 30 minutes or longer. The modified gluten is suitably used as a bread dough modifying agent, particularly as a frozen bread dough modifying agent.

Gluten is a protein formed by interaction between gliadin and glutenine when water is added to cereal flour such as wheat and rye and these are mixed together, and it is characterized by exhibiting viscoelasticity, water absorbing property, and extensibility/elongation property. Gluten can be separated by washing away the starch from the dough prepared by adding water to wheat flour and mixing these together. The gluten to be used in the present invention may be any gluten, and the cereal from which gluten is derived and the method for separating gluten are also not particularly limited, but gluten derived from wheat is preferable. In addition, the separated gluten may be any of wet type (raw gluten) gluten as it has been separated or vital gluten obtained by drying the wet type gluten by various kinds of drying methods such as a flash drying method, a spray drying method, a vacuum drying method, and a freeze drying method, but vital gluten is preferable. In the case of using vital gluten, the water content therein is preferably less than 10%, more preferably less than 9%, still more preferably less than 8%, and most preferably less than 6%.

The organic acid to be used in the present invention is an organic acid having two or more carbonyl groups, preferably two or more carboxyl groups in the same molecule, which may be a cis-isomer, a trans-isomer or a racemate. As the organic acid having two or more carbonyl groups in the same molecule, succinic acid, malic acid, malonic acid, glutaric acid and adipic acid are preferable, succinic acid or malic acid is more preferable, and succinic acid is still more preferable. In addition, one kind of organic acid may be used, or two or more kinds of organic acids may be used concurrently.

In the present invention, when performing a heat treatment of a solution containing gluten and an organic acid having two or more carbonyl groups in the same molecule (hereinafter simply referred to as an organic acid), the amount of the organic acid to gluten is, for example, 0.5 part by weight or more, preferably 1.0 part by weight or more, more preferably 2.0 parts by weight or more, and still more preferably 4.0 parts by weight or more per 100 parts by weight of gluten. In addition, the upper limit of the amount of the organic acid to gluten is not particularly limited, but for example, it is less than 100 parts by weight, preferably less than 50 parts by weight, more preferably less than 15 parts by weight, still more preferably less than 13.5 parts by weight, yet more preferably less than 12 parts by weight, yet still more preferably less than 11 parts by weight, and most preferably less than 10 parts by weight per 100 parts by weight of gluten in order to ensure that the gluten is sufficiently reacted with the organic acid and the taste of the organic acid does not remain in the final product.

It is preferable that the heat treatment is performed in a state in which the organic acid is dissolved in a liquid medium, and the liquid to be the medium is preferably water. The method for preparing a solution containing gluten and an organic acid may be any of a method in which gluten is dispersed in a liquid and then an organic acid or a solution of an organic acid is added to the dispersion liquid, a method in which a solution of an organic acid is added to gluten, a method in which a liquid is added to a mixture of gluten and an organic acid, or a method in which a mixture of gluten and an organic acid is added to a liquid.

The temperature for the heat treatment is preferably 65° C. or higher, more preferably 70° C. or higher, and still more preferably 80° C. or higher. Gluten and the like form a lump at 40° C., and these do not form a lump but intended modified gluten cannot be obtained at 50° C. to 60° C. In addition, the upper limit of the temperature for the heat treatment is not particularly limited, but it is 100° C. or lower, preferably lower than 100° C., more preferably lower than 95° C., and still more preferably 90° C. or lower when the fact that the reaction is a reaction in an aqueous solution and the reaction product is a protein which undergoes thermal denaturation is taken into consideration.

The time for the heat treatment may be appropriately adjusted depending on the temperature for the heat treatment, but it is preferably 30 minutes or longer, preferably 60 minutes or longer, more preferably 90 minutes or longer, still more preferably 120 minutes or longer, yet more preferably 150 minutes or longer, and most preferably 240 minutes or longer. The upper limit of the time for the heat treatment is not particularly determined, but it is preferably 1440 minutes or shorter, more preferably 1080 minutes or shorter, still more preferably 720 minutes or shorter, yet more preferably 600 minutes or shorter, and most preferably 480 minutes or shorter when the industrial productivity is taken into consideration.

The gluten obtained through the heat treatment (hereinafter referred to as “modified gluten”) may be used as it is or may be used after being dried, solidified and powdered. The drying method is not particularly limited, and various kinds of drying methods such as a flash drying method, a spray drying method, a drum drying method, a vacuum drying method and a freeze drying method can be used.

The modified gluten of the present invention can also be used as a raw material for foods such as sweets using gluten and gluten meat. In addition, in order to strengthen the gluten network, for example, the modified gluten can also be used as a modifying agent for mouthfeel of noodles and the like, but it is preferably used as a bread dough modifying agent.

The modified gluten of the present invention exhibits freezing tolerance and can be used in a frozen dough and a refrigerated dough. The following effects (freezing tolerance) with respect to refrigeration troubles are obtained in the case of using the modified gluten of the present invention in a frozen dough. In other words, degradation of the gluten network due to freezing is suppressed and it is possible to prevent the disadvantages such as changes in appearance due to freezing (a decrease in volume, deterioration in firmness, and the like), changes in the inner layer (rough texture, generation of cavities, and the like), and changes in mouthfeel (deterioration in soft and elastic mouthfeel and the like). More specifically, it does not occur that the bread dough becomes flat and the bottom face thereof is entirely attached, but the bread dough rises from the bottom face and can hold the round shape when viewed from the side even when the modified gluten of the present invention is added to a bread dough and the bread dough is deep-frozen for a certain period of time, then thawed and baked. In this manner, a state in which the side face of the bread after oven-spring does not fall but holds a favorable shape and the bottom face is small and has a high height is said that the “firmness” is favorable. In addition, the period of deep freeze described above is, for example, about one week to about two months.

The modified gluten of the present invention can be used singly as a bread dough modifying agent, but it may be formulated by being mixed with other food materials, additives, perfumes, coloring matters and the like that are generally used in the manufacture of bread. For example, the bread dough modifying agent may contain various kinds of edible fats and oils, dairy products, fruit juice, cereal flour and the like, an emulsifier such as monoglyceride, succinic acid monoglyceride, diacetyl tartaric acid monoglyceride, sucrose fatty acid ester, lecithin, enzyme decomposed lecithin, sodium stearoyl lactylate or calcium stearoyl lactate, enzymes such as α-amylase, β-amylase, glucoamylase, hemicellulase (pentosanase), cellulase, and glucose oxidase, protease, amino acids such as cysteine, cystine, methionine, alanine, aspartic acid, and glycine, collagen, soybean proteins, peptides and the like, inorganic salts such as sodium chloride, potassium chloride, ammonium chloride, calcium sulfate, calcium carbonate, and calcium dihydrogenphosphate, nucleic acids such as sodium inosinate and sodium guanylate, vitamins such as vitamin B₁, vitamin B₂, vitamin C (L-ascorbic acid), and vitamin E, alcohols such as ethanol and glycerol, saccharides such as sucrose, glucose, maltose and lactose, thickening polysaccharides such as gum arabic, alginic acid, carrageenan, xanthan gum, guar gum, tamarind gum, and pectin, and excipients such as dextrin and various kinds of starch. In addition, the form of the bread dough modifying agent is not particularly limited, and it may be any form of a liquid form, a granular form, a paste form, or an emulsion form.

The preparation of a bread dough and manufacture of bread using the modified gluten of the present invention can be performed by a usual method except that the modified gluten of the present invention is added to the cereal flour dough raw materials for bread making. In addition, the modified gluten of the present invention may be mixed with wheat flour and the like in advance to obtain a mixed powder.

Examples of the cereal flour to be used in the preparation of a bread dough may include cereal flour obtained from cereals such as wheat, rice, barley, and rye, and wheat flour is preferably used. As the wheat flour, any kind and grade of strong flour, semi-strong flour, medium flour or soft flour may be used.

The amount of the modified gluten of the present invention added to the cereal flour dough is usually 0.1 to 10 parts by weight, preferably 0.1 to 5 parts by weight, more preferably 1 to 5 parts by weight per 100 parts by weight of cereal flour.

The kind of bread to be manufactured in the present invention is not limited, and the bread includes cake and confectioneries such as steamed buns, donuts, cookies, crackers, pies, pizza, pancake, and sponge cake in addition to bread such as pan loaf, roll bread, hard-baked bread, confectionery bread (chocolate paste-containing cornets, jammed bread, and the like), cooked bread (sandwiches, hamburgers, curry bread and the like), and steamed bread.

Raw materials for bread dough include cereal flour (wheat flour, rye flour, rice flour, corn flour and the like) as the main raw material, water, yeast, salt, saccharides, fats and oils (shortening, lard, margarine, butter and the like) as auxiliary materials, dairy products (milk, skimmed milk powder, whole milk powder, condensed milk and the like), eggs, yeast food and the like.

Examples of a representative bread making method may include a straight dough method, a sponge and dough method, and a liquid ferment method, but the bread dough modifying agent containing the modified gluten of the present invention can be applied to any bread making method of a straight dough method, a sponge and dough method, a liquid ferment method, or the like.

The straight dough method is a method in which all raw materials for the bread dough are mixed together at the beginning. The a sponge and dough method is a method in which a sponge dough is made by adding yeast (including lactic acid bacteria in the case of sourdough) and water to a part of cereal flour and fermenting the mixture and the sponge after the fermentation is added to the remaining raw materials for the bread dough. The liquid ferment method (α-dough method/hot mixing method) is a method in which a part of wheat flour is mixed with hot water to gelatinize the starch and this is added to a bread dough.

In the straight dough method, all raw materials for the bread dough are mixed and then the mixture is fermented at 25° C. to 30° C., divided, takes the bench time, and is molded and shaped. The shaped dough is subjected to proofing (25° C. to 42° C.) and then baked (170° C. to 240° C.). In the sponge and dough method, water is added to cereal flour to be 30% to 100% by weight of the entire amount of the cereal flour to be used, yeast, yeast food and the like, the raw materials are mixed together to obtain a sponge dough, then the sponge dough is fermented at 25° C. to 35° C. for 1 to 5 hours, the remaining raw materials for the bread dough are added to the fermented sponge dough, and these are mixed together (main mixing), and the mixture takes the floor time, is divided, takes the bench time, and is molded and shaped. The shaped dough is subjected to proofing (25° C. to 42° C.) and then baked (170° C. to 240° C.).

The modified gluten of the present invention may be added at any time during the bread making process. For example, in the case of the straight dough method, the bread dough may be prepared by adding the modified gluten to the raw materials for the bread dough or the modified gluten may be added when the raw materials are put together and then the bread dough is mixed. In the case of the sponge and dough method, the modified gluten may be added to the raw materials to constitute the sponge, the modified gluten may be added at the time of mixing of the sponge, or the modified gluten may be added to the bread dough at the time of main mixing after fabrication of the sponge. In addition, the method for adding the modified gluten to the raw materials for the bread dough and the bread dough may be a method in which the modified gluten is mixed with the cereal flour or a method in which the modified gluten is added after being dissolved or dispersed in a liquid such as water in the case of dried modified gluten.

In addition, in a case in which the bread dough is a frozen bread dough, the method for manufacturing the frozen bread dough is not particularly limited, and any of a plate dough freezing method in which the dough is frozen immediately after mixing, a dough ball freezing method in which the dough is frozen after dividing and rounding but before molding, a molding and freezing method in which the dough is frozen after molding, or a proofing and freezing method in which the dough is frozen after the final fermentation (proofing) may be used.

Hereinafter, the contents of the present invention will be described using Examples. However, the technical scope of the present invention is not limited to these Examples.

In the tables presenting the compositions of the bread doughs manufactured in the following Examples, the amounts of the raw materials blended are described in terms of Baker's percent (parts by weight) with respect to 100 parts by weight of strong flour. In addition, DAIYA YEAST FRZ (MC Food Specialties Inc.) was used as the yeast for frozen dough. DAIYA YEAST YST (MC Food Specialties Inc.) was used as the yeast for scratch dough. Incidentally, the yeast for frozen dough can also be used as the yeast for scratch dough.

### EXAMPLES

### (Example 1) Investigation on Kind of Organic Acid (1)

(1) Preparation of Sample

To 500 mL of distilled water, 4.00 g (0.034 mol) of succinic acid was added and mixed to obtain a mixed solution. To the mixed solution obtained, 100 g of vital gluten (water content: 5.8 W/W %) was added, and the mixture was heated to 80° C. by using a water bath while being sufficiently stirred. After the temperature reached to 80° C., stirring was further performed for 300 minutes to react the vital gluten with succinic acid. The reaction solution obtained was emulsified for 120 seconds by using a homogenizer. The emulsified solution was spread on a vat and dried by using a freeze dryer to obtain a dried product (water content: 7.0 W/W %). The dried product was pulverized by using a food processor, thereby obtaining Powder A.

Powder B was obtained in the same manner except that 4.00 g of succinic acid was changed to 4.56 g (0.034 mol) of malic acid.

In addition, Powder C was obtained in the same manner except that 4.00 g of succinic acid was changed to 6.53 g (0.034 mol) of citric acid.

(2) Preparation of Bread Dough and Bread Making

In the blending amounts presented in the following Table 1, the raw materials (wheat flour (strong flour), yeast for frozen dough, granulated sugar, salt, skimmed milk powder, and water) were mixed with Powder A (gluten treated with succinic acid) for Invention Product A, Powder B (gluten treated with malic acid) for Invention Product B, Powder C (gluten treated with citric acid) for Invention Product C, and untreated vital gluten for Comparative Product 1, respectively.

TABLE 1

| | | | Invention | Invention | Invention |
|---|---|---|---|---|---|
| | Additive-free | Comparative | Product | Product | Product |
| | Product | Product 1 | A | B | C |
| Strong flour | 100 | 100 | 100 | 100 | 100 |
| Yeast for frozen dough | 3 | 3 | 3 | 3 | 3 |
| Granulated sugar | 15 | 15 | 15 | 15 | 15 |
| Salt | 1.5 | 1.5 | 1.5 | 1.5 | 1.5 |
| Skimmed milk powder | 2 | 2 | 2 | 2 | 2 |
| Shortening | 12 | 12 | 12 | 12 | 12 |
| Untreated vital gluten | | 3 | | | |
| Powder A (gluten treated with succinic acid) | | | 3 | | |
| Powder B (gluten treated with malic acid) | | | | 3 | |
| Powder C (gluten treated with citric acid) | | | | | 3 |
| Water | 58 | 60 | 60 | 60 | 60 |

The mixed raw materials were mixed at a low speed for 3 minutes, at a medium speed for 2 minutes, and at a high speed for 2 minutes. After the addition of shortening, the mixture was further mixed at a low speed for 2 minutes, at a medium speed for 3 minutes, and at a high speed for 2 minutes, thereby obtaining a mainly mixed dough. Incidentally, the mixing was adjusted so that the final dough temperature was 24° C. After taking the floor time at 28° C. for 30 minutes, the mainly mixed dough was divided into small doughs so that each had a weight of 50 g, and the small doughs took the bench time for 20 minutes and each were subjected to roll molding using a molder. The frozen doughs obtained by rapid freezing at −40° C. for 60 minutes were deep-frozen at −25° C. for a predetermined period of time. After deep freeze, the frozen doughs were allowed to still stand for 30 minutes under the conditions of 30° C. and a humidity of 65% to be thawed, and the final fermentation thereof was performed for 60 minutes under the conditions of 38° C. and a humidity of 85%. Thereafter, the doughs fermented were baked for 9 minutes in an oven (upper fire: 210° C. and lower fire: 190° C.), thereby manufacturing roll bread. Incidentally, six pieces of roll bread were manufactured for each test section (Invention Products A to C sections, Comparative Product 1 section, and Additive-free Product section).

(3) Evaluation Method

The roll bread manufactured in (2) was subjected to the appearance observation and the specific volume, height, and firmness of the bread were measured by the following methods.

Specific volume: Three pieces of roll bread per each test section were subjected to the measurement of weight and volume two times, the volume/weight was calculated, and the average value thereof was determined. The volume was measured by the following rapeseed substitution method (see page 22 in Handbook of Experiments in Food Processing, written by Takao Mori).

<Rapeseed Substitution Method>

A container one size larger than the specimen is prepared, and rapeseed is filled in the container and levelled. The rapeseed in the container is once taken out, the bread is put in the container, and the rapeseed is filled in the container again and levelled. The volume of rapeseed overflowed is measured by using a measuring cylinder. This volume of rapeseed corresponds to the volume of the specimen.

Height of bread: The highest portion of bread was measured by using a vernier caliper for six pieces of roll bread per each test section, and the average value thereof was determined.

Firmness of bread: The “portion (α) having the widest width of bread” and the “widest width (γ) on the surface in contact with the top plate of bread”) (see FIG. 15) were measured by using the vernier caliper for the six pieces of roll bread per each test section, and the average value of the values calculated by the following Formula β was determined.

Firmness=1−(γ/α) (Formula β)

(4) Evaluation Result

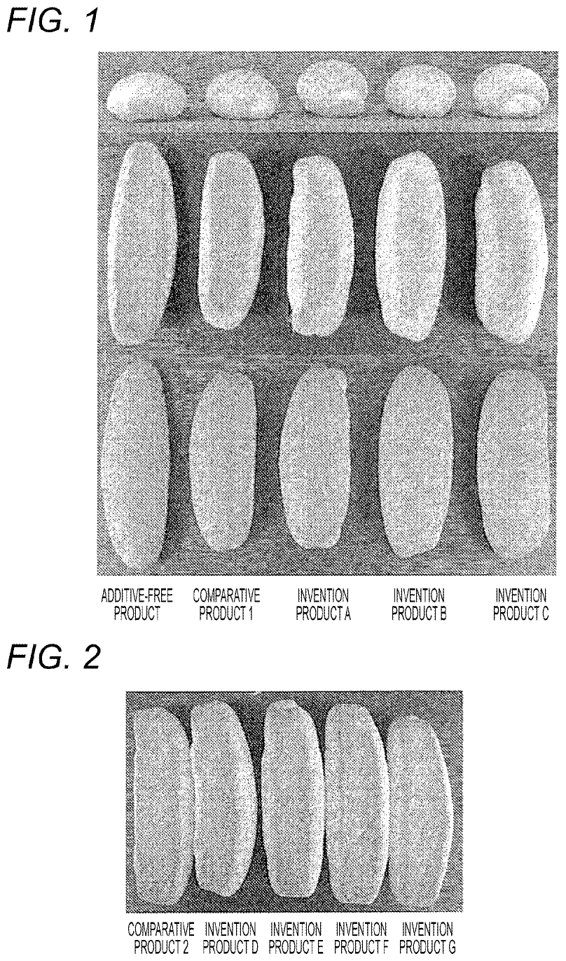

The results on appearance observation are illustrated in FIG. 1, and the measurement results for the specific volume, height, and firmness of the bread are presented in the following Table 2.

TABLE 2

| | | | Comparative | Invention | Invention | Invention |
|---|---|---|---|---|---|---|
| | Period of | Additive-free | Product 1 | Product A | Product B | Product C |
| | deep freeze | Product section | section | section | section | section |
| Specific | For 1 day | 4.64 | 4.78 | 6.01 | 5.94 | 5.88 |
| volume | For 7 days | 4.58 | 4.62 | 5.97 | 5.83 | 5.73 |
| (mL/g) | For 14 days | 4.38 | 4.39 | 5.77 | 5.77 | 5.49 |
| Height (mm) | For 1 day | 32.2 | 34.1 | 42.8 | 41.9 | 40.7 |
| | For 7 days | 31.3 | 33.4 | 42.3 | 42.0 | 41.3 |
| | For 14 days | 31.3 | 34.3 | 41.8 | 41.2 | 40.0 |
| Firmness | For 1 day | 0.25 | 0.26 | 0.49 | 0.49 | 0.47 |
| | For 7 days | 0.24 | 0.25 | 0.52 | 0.50 | 0.49 |
| | For 14 days | 0.26 | 0.31 | 0.49 | 0.47 | 0.48 |

As presented in Table 2, in Invention Products A to C sections in which Powder A (gluten treated with succinic acid), Powder B (gluten treated with malic acid), and Powder C (gluten treated with citric acid) were respectively used, all of the specific volume, height, and firmness of the roll bread after being baked had higher values than those of Additive-free Product section and Comparative Product 1 section in which untreated vital gluten was used. In addition, the high values were continuously kept even after 14 days of deep freeze in the case of using Powders A to C. In addition, as illustrated in FIG. 1, the roll bread had a shape with favorable firmness in the case of using Powders A to C. From the above results, it has been found that gluten treated with an organic acid (succinic acid, malic acid, and citric acid) has an effect of imparting excellent freezing tolerance to a bread dough.

### (Example 2) Investigation on Kind of Organic Acid (2)

### (1) Preparation of Sample

To 500 mL of distilled water, 8.85 g (0.085 mol) of malonic acid was added and mixed to obtain a mixed solution. To the mixed solution obtained, 100 g of vital gluten (water content: 5.8 W/W %) was added, and the mixture was heated to 75° C. by using a water bath while being sufficiently stirred. After the temperature reached to 75° C., stirring was further performed for 90 minutes to react the vital gluten with malonic acid. The reaction solution (pH: 2.56) obtained was emulsified for 120 seconds by using a homogenizer. The emulsified solution was spread on a vat and dried by using a freeze dryer to obtain a dried product (water content: 8.8 W/W %). The dried product was pulverized by using a food processor, thereby obtaining Powder D.

A reaction solution (pH: 3.47) was obtained in the same manner except that 8.85 g of malonic acid was changed to 10.00 g (0.085 mol) of succinic acid, and then the emulsification and drying treatments were performed, thereby obtaining Powder E.

A reaction solution (pH: 3.79) was obtained in the same manner except that 8.85 g of malonic acid was changed to 11.23 g (0.085 mol) of glutaric acid, and then the emulsification and drying treatments were performed, thereby obtaining Powder F.

A reaction solution (pH: 3.85) was obtained in the same manner except that 8.85 g of malonic acid was changed to 12.40 g (0.085 mol) of adipic acid, and then the emulsification and drying treatments were performed, thereby obtaining Powder G.

Incidentally, the solution prepared by dissolving vital gluten in 500 mL of distilled water had a pH of 4.97.

(2) Preparation of Bread Dough and Bread Making

Bread doughs were prepared and roll bread of each test section (Invention Product D section, Invention Product E section, Invention Product F section, Invention Product G section, and Comparative Product 2 section) was manufactured in the same manner as in Example 1 except that Powder D (gluten treated with malonic acid), Powder E (gluten treated with succinic acid), Powder F (gluten treated with glutaric acid) or Powder G (gluten treated with adipic acid) prepared in (1) or untreated vital gluten was used and the respective raw materials were mixed so that the blending amounts presented in the following Table 3 were obtained.

TABLE 3

| | Comparative | Invention | Invention | Invention | Invention |
|---|---|---|---|---|---|
| | Product 2 | Product D | Product E | Product F | Product G |
| Strong flour | 100 | 100 | 100 | 100 | |
| Yeast for frozen dough | 3 | 3 | 3 | 3 | 3 |
| Granulated sugar | 15 | 15 | 15 | 15 | 15 |
| Salt | 1.5 | 1.5 | 1.5 | 1.5 | 1.5 |
| Skimmed milk powder | 2 | 2 | 2 | 2 | 2 |
| Shortening | 12 | 12 | 12 | 12 | 12 |
| Untreated vital gluten | 3 | | | | |
| Powder D (gluten treated with malonic acid) | | 3 | | | |
| Powder E (gluten treated with succinic acid) | | | 3 | | |
| Powder F (gluten treated with glutaric acid) | | | | 3 | |
| Powder G (gluten treated with adipic acid) | | | | | 3 |
| Water | 60 | 60 | 60 | 60 | 60 |

(3) Evaluation Method

The roll bread manufactured in (2) was subjected to the appearance observation and the specific volume, height, and firmness of the bread were measured in the same manner as in Example 1.

(4) Evaluation Result

The results on appearance observation are illustrated in FIG. 2, and the measurement results for the specific volume, height, and firmness of the bread are presented in the following Table 4.

TABLE 4

| | | Comparative | Invention | Invention | Invention | Invention |
|---|---|---|---|---|---|---|
| | Period of | Product 2 | Product D | Product E | Product F | Product G |
| | deep freeze | section | section | section | section | section |
| Specific | For 1 day | 5.66 | 6.20 | 6.43 | 6.30 | 6.05 |
| volume | For 7 days | 5.02 | 5.65 | 5.55 | 5.46 | 5.55 |
| (mL/g) | For 14 days | 4.78 | 5.37 | 5.56 | 5.33 | 5.03 |
| | For 30 days | 4.60 | 5.32 | 5.14 | 5.04 | 5.08 |
| Height (mm) | For 1 day | 37.8 | 41.4 | 40.9 | 41.3 | 41.1 |
| | For 7 days | 35.5 | 40.1 | 38.3 | 38.0 | 38.6 |
| | For 14 days | 34.9 | 38.6 | 39.0 | 38.5 | 37.8 |
| | For 30 days | 34.0 | 39.6 | 38.7 | 37.5 | 38.0 |
| Firmness | For 1 day | 0.40 | 0.46 | 0.47 | 0.45 | 0.46 |
| | For 7 days | 0.36 | 0.47 | 0.48 | 0.46 | 0.45 |
| | For 14 days | 0.34 | 0.42 | 0.45 | 0.42 | 0.43 |
| | For 30 days | 0.35 | 0.44 | 0.46 | 0.44 | 0.38 |

As presented in Table 4, in Invention Products D to G sections in which Powder D (gluten treated with malonic acid), Powder E (gluten treated with succinic acid), Powder F (gluten treated with glutaric acid), and Powder G (gluten treated with adipic acid) were respectively used, all of the specific volume, height, and firmness of the roll bread after being baked had higher values than those of Comparative Product 2 section in which untreated vital gluten was used. In addition, the high values were continuously kept even after 30 days of deep freeze in the case of using Powders D to G. In addition, as illustrated in FIG. 2, the roll bread had a shape with favorable firmness in the case of using Powders D to G. From the above results, it has been found that gluten treated with an organic acid (malonic acid, succinic acid, glutaric acid, and adipic acid) has an effect of imparting excellent freezing tolerance to a bread dough.

### (Example 3) Investigation on Amount of Organic Acid (1)

(1) Preparation of Sample

To 500 mL of distilled water, 2.00 g (0.017 mol) of succinic acid was added and mixed to obtain a mixed solution. To the mixed solution obtained, 100 g of vital gluten (water content: 5.8 W/W %) was added, and the mixture was heated to 75° C. by using a water bath while being sufficiently stirred. After the temperature reached to 75° C., stirring was further performed for 90 minutes to react the vital gluten with succinic acid. The reaction solution (pH: 4.36) obtained was emulsified for 120 seconds by using a homogenizer. The emulsified solution was spread on a vat and dried by using a freeze dryer to obtain a dried product (water content: 5.2 W/W %). The dried product was pulverized by using a food processor, thereby obtaining Powder H.

A reaction solution was obtained in the same manner except that 2.00 g of succinic acid was changed to 4.00 g (0.034 mol) of succinic acid, and then the emulsification and drying treatments were performed, thereby obtaining Powder I.

A reaction solution was obtained in the same manner except that 2.00 g of succinic acid was changed to 6.00 g (0.051 mol) of succinic acid, and then the emulsification and drying treatments were performed, thereby obtaining Powder J.

A reaction solution was obtained in the same manner except that 2.00 g of succinic acid was changed to 8.00 g (0.068 mol) of succinic acid, and then the emulsification and drying treatments were performed, thereby obtaining Powder K.

A reaction solution was obtained in the same manner except that 2.00 g of succinic acid was changed to 10.00 g (0.085 mol) of succinic acid, and then the emulsification and drying treatments were performed, thereby obtaining Powder L.

In addition, the pH and viscosity (temperature at the time of viscosity measurement: 35° C.) of the reaction solutions were measured at the stage of the reaction solution in the preparation of Powders H, I and L described above. The results are presented in Table 5.

TABLE 5

| | Invention | Invention | Invention |
|---|---|---|---|
| | Product H | Product L | Product L |
| pH of reaction solution | 4.36 | 4.05 | 3.6 |
| Viscosity of reaction solution (Pa · s) | 4800 | 11200 | 15800 |

(2) Preparation of bread dough and bread making Bread doughs were prepared and roll bread of each test section (Invention Product H section, Invention Product I section, Invention Product J section, Invention Product K section, Invention Product L section, and Comparative Product 3 section) was manufactured in the same manner as in Example 1 except that Powder H (gluten treated with 2.00 g of succinic acid), Powder I (gluten treated with 4.00 g of succinic acid), Powder J (gluten treated with 6.00 g of succinic acid), Powder K (gluten treated with 8.00 g of succinic acid) or Powder L (gluten treated with 10.00 g of succinic acid) prepared in (1) or untreated vital gluten was used and the respective raw materials were mixed so that the blending amounts presented in the following Table 6 were obtained.

TABLE 6

| | Comparative | Invention | Invention | Invention | Invention | Invention |
|---|---|---|---|---|---|---|
| | Product 3 | Product H | Product I | Product J | Product K | Product L |
| Strong flour | 100 | 100 | 100 | 100 | 100 | 100 |
| Yeast for frozen dough | 3 | 3 | 3 | 3 | 3 | 3 |
| Granulated sugar | 15 | 15 | 15 | 15 | 15 | 15 |
| Salt | 1.5 | 1.5 | 1.5 | 1.5 | 1.5 | 1.5 |
| Skimmed milk powder | 2 | 2 | 2 | 2 | 2 | 2 |
| Shortening | 12 | 12 | 12 | 12 | 12 | 12 |
| Untreated vital gluten | 3 | | | | | |
| Powder H (2.00 g) | | 3 | | | | |
| Powder H (4.00 g) | | | 3 | | | |
| Powder H (6.00 g) | | | | 3 | | |
| Powder H (8.00 g) | | | | | 3 | |
| Powder H (10.00 g) | | | | | | 3 |
| Water | 60 | 60 | 60 | 60 | 60 | 60 |

(3) Evaluation Method

The roll bread manufactured in (2) was subjected to the appearance observation and the specific volume, height, and firmness of the bread were measured in the same manner as in Example 1.

(4) Evaluation Result

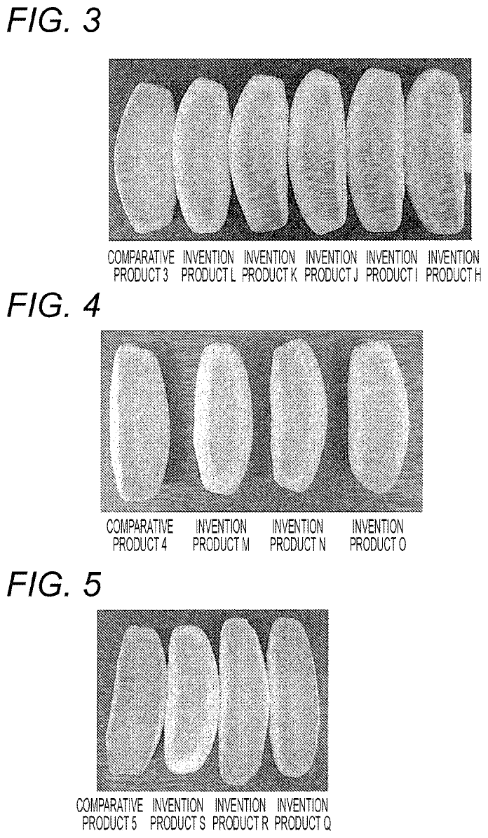

The results on appearance observation are illustrated in FIG. 3, and the measurement results for the specific volume, height, and firmness of the bread are presented in the following Table 7.

TABLE 7

| | | Comparative | Invention | Invention | Invention | Invention | Invention |
|---|---|---|---|---|---|---|---|
| | Period of | Product 3 | Product H | Product I | Product J | Product K | Product L |
| | deep freeze | section | section | section | section | section | section |
| Specific | For 1 day | 5.38 | 5.96 | 5.84 | 6.22 | 5.85 | 6.11 |
| volume | For 7 days | 4.87 | 5.44 | 5.26 | 5.21 | 5.21 | 5.32 |
| (mL/g) | For 14 days | 4.29 | 4.72 | 4.54 | 4.75 | 4.57 | 4.68 |
| | For 30 days | 4.29 | 5.02 | 4.78 | 4.86 | 4.75 | 4.66 |
| Height (mm) | For 1 day | 37.5 | 40.0 | 41.0 | 40.4 | 40.2 | 41.5 |
| | For 7 days | 36.0 | 38.5 | 36.9 | 38.2 | 38.9 | 39.0 |
| | For 14 days | 34.5 | 37.5 | 35.8 | 37.6 | 37.5 | 37.6 |
| | For 30 days | 32.5 | 35.5 | 35.2 | 35.8 | 36.1 | 35.5 |
| Firmness | For 1 day | 0.35 | 0.42 | 0.44 | 0.44 | 0.42 | 0.39 |
| | For 7 days | 0.28 | 0.39 | 0.37 | 0.41 | 0.42 | 0.46 |
| | For 14 days | 0.27 | 0.37 | 0.35 | 0.41 | 0.37 | 0.36 |
| | For 30 days | 0.22 | 0.33 | 0.34 | 0.36 | 0.36 | 0.36 |

As presented in Table 7, in Invention Products H to L sections in which Powder H (gluten treated with 2.00 g of succinic acid), Powder I (gluten treated with 4.00 g of succinic acid), Powder J (gluten treated with 6.00 g of succinic acid), Powder K (gluten treated with 8.00 g of succinic acid) and Powder L (gluten treated with 10.00 g of succinic acid) were respectively used, all of the specific volume, height, and firmness of the roll bread after being baked had higher values than those of Comparative Product 3 section in which untreated vital gluten was used. In addition, the high values were continuously kept even after 30 days of deep freeze in the case of using Powders H to L. In addition, as illustrated in FIG. 3, the roll bread had a shape with favorable firmness in the case of using Powders H to L. From the above results, it has been found that gluten treated with an organic acid (succinic acid), which is obtained by reacting 100 parts by weight of gluten with 2 to 10 parts by weight of an organic acid (succinic acid), has an effect of imparting excellent freezing tolerance to a bread dough.

### (Example 4) Investigation on Reaction Temperature (1)

(1) Preparation of Sample

To 500 mL of distilled water, 4.00 g (0.034 mol) of succinic acid was added and mixed to obtain a mixed solution. To the mixed solution obtained, 100 g of vital gluten (water content: 5.8 W/W %) was added, and the mixture was heated to 70° C. by using a water bath while being sufficiently stirred. After the temperature reached to 70° C., stirring was further performed for 300 minutes to react the vital gluten with succinic acid. The reaction solution obtained was emulsified for 120 seconds by using a homogenizer. The emulsified solution was spread on a vat and dried by using a freeze dryer to obtain a dried product (water content: 5.2 W/W %). The dried product was pulverized by using a food processor, thereby obtaining Powder M.

Powder N was obtained in the same manner except that the reaction temperature was changed from 70° C. to 80° C.

Powder O was obtained in the same manner except that the reaction temperature was changed from 70° C. to 90° C.

(2) Preparation of Bread Dough and Bread Making

Bread doughs were prepared and roll bread of each test section (Invention Product M section, Invention Product N section, Invention Product 0 section, and Comparative Product 4 section) was manufactured in the same manner as in Example 1 except that Powder M (gluten treated with succinic acid at 70° C.), Powder N (gluten treated with succinic acid at 80° C.) or Powder O (gluten treated with succinic acid at 90° C.) prepared in (1) or untreated vital gluten was used and the respective raw materials were mixed so that the blending amounts presented in the following Table 8 were obtained.

TABLE 8

| | Comparative | Invention | Invention | Invention |
|---|---|---|---|---|
| | Product 4 | Product M | Product N | Product O |
| Strong flour | 100 | 100 | 100 | 100 |
| Yeast for frozen dough | 3 | 3 | 3 | 3 |
| Granulated sugar | 15 | 15 | 15 | 15 |
| Salt | 1.5 | 1.5 | 1.5 | 1.5 |
| Skimmed milk powder | 2 | 2 | 2 | 2 |
| Shortening | 12 | 12 | 12 | 12 |
| Untreated vital gluten | 3 | | | |
| Powder M (70° C.) | | 3 | | |
| Powder N (80° C.) | | | 3 | |
| Powder O (90° C.) | | | | 3 |
| Water | 60 | 60 | 60 | 60 |

(3) Evaluation Method

The roll bread manufactured in (2) was subjected to the appearance observation and the specific volume, height, and firmness of the bread were measured in the same manner as in Example 1.

(4) Evaluation Result

The results on appearance observation are illustrated in FIG. 4, and the measurement results for the specific volume, height, and firmness of the bread are presented in the following Table 9.

TABLE 9

| | | Com- | | | |
|---|---|---|---|---|---|
| | | parative | Invention | Invention | Invention |
| | Period of | Product 4 | Product M | Product N | Product O |
| | deep freeze | section | section | section | section |
| Specific | For 1 day | 5.33 | 5.92 | 5.82 | 5.85 |
| volume | For 7 days | 4.92 | 5.76 | 5.48 | 5.59 |
| (mL/g) | For 14 days | 5.00 | 5.70 | 5.79 | 5.79 |
| | For 30 days | 4.29 | 4.99 | 5.07 | 5.24 |
| Height | For 1 day | 36.1 | 41.8 | 43.0 | 43.1 |
| (mm) | For 7 days | 34.8 | 41.0 | 40.6 | 41.7 |
| | For 14 days | 33.9 | 39.5 | 41.5 | 42.0 |
| | For 30 days | 34.5 | 39.7 | 40.9 | 41.4 |
| Firm- | For 1 day | 0.34 | 0.49 | 0.51 | 0.49 |
| ness | For 7 days | 0.28 | 0.46 | 0.47 | 0.48 |
| | For 14 days | 0.27 | 0.46 | 0.43 | 0.45 |
| | For 30 days | 0.31 | 0.51 | 0.52 | 0.48 |

As presented in Table 9, in Invention Products M to O sections in which Powder M (gluten treated with succinic acid at 70° C.), Powder N (gluten treated with succinic acid at 80° C.), and Powder O (gluten treated with succinic acid at 90° C.) were respectively used, all of the specific volume, height, and firmness of the roll bread after being baked had higher values than those of Comparative Product 4 section in which untreated vital gluten was used. In addition, the high values were continuously kept even after 30 days of deep freeze in the case of using Powders M to O. In addition, as illustrated in FIG. 4, the roll bread had a shape with favorable firmness in the case of using Powders M to O. From the above results, it has been found that gluten treated with an organic acid (succinic acid), which is obtained by reacting gluten with an organic acid (succinic acid) at 70° C. to 90° C., has an effect of imparting excellent freezing tolerance to a bread dough.

### (Example 5) Investigation on Reaction Temperature (2)

(1) Preparation of Sample

To 500 mL of distilled water, 10.00 g (0.085 mol) of succinic acid was added and mixed to obtain a mixed solution. To the mixed solution obtained, 100 g of vital gluten (water content: 5.8 W/W %) was added, and the mixture was heated to 40° C. by using a water bath while being sufficiently stirred. After the temperature reached to 40° C., stirring was further performed for 90 minutes to react the vital gluten with succinic acid. However, it was determined that the reaction did not proceed since the reaction solution obtained formed a lump in the liquid at the time of heating at 40° C., and thus powdering was not performed.

To 500 mL of distilled water, 10.00 g (0.085 mol) of succinic acid was added and mixed to obtain a mixed solution. To the mixed solution obtained, 100 g of vital gluten (water content: 5.8 W/W %) was added, and the mixture was heated to 50° C. by using a water bath while being sufficiently stirred. After the temperature reached to 50° C., stirring was further performed for 90 minutes to react the vital gluten with succinic acid. The reaction solution obtained was emulsified for 120 seconds by using a homogenizer. The emulsified solution was spread on a vat and dried by using a freeze dryer to obtain a dried product (water content: 5.6 W/W %). The dried product was pulverized by using a food processor, thereby obtaining Powder Q.

Powder R was obtained in the same manner except that the reaction temperature was changed from 50° C. to 60° C.

Powder S was obtained in the same manner except that the reaction temperature was changed from 50° C. to 70° C.

In addition, the pH and viscosity (temperature at the time of viscosity measurement: 35° C.) of the reaction solutions were measured at the stage of the reaction solution in the preparation of Powders P to S described above. The results are presented in Table 10.

TABLE 10

| | Powder | Powder | Powder | Powder |
|---|---|---|---|---|
| | P(*) | Q | R | S |
| pH of reaction solution | 3.68 | 3.57 | 3.60 | 3.65 |
| Viscosity of reaction | 435 | 392 | 570 | 15000 |
| solution (Pa · s) | | | | |

*Powder P is named as Powder P for the convenience although powdering has not been actually performed.

(2) Preparation of Bread Dough and Bread Making

Bread doughs were prepared and roll bread of each test section (Comparative Product Q section, Comparative Product R section, Invention Product S section, and Comparative Product 5 section) was manufactured in the same manner as in Example 1 except that Powder Q (gluten treated with succinic acid at 50° C.), Powder R (gluten treated with succinic acid at 60° C.) or Powder S (gluten treated with succinic acid at 70° C.) prepared in (1) or untreated vital gluten was used and the respective raw materials were mixed so that the blending amounts presented in the following Table 11 were obtained.

TABLE 11

| | Com- | Com- | Com- | |
|---|---|---|---|---|
| | parative | parative | parative | Invention |
| | Product 5 | Product Q | Product R | Product S |
| Strong flour | 100 | 100 | 100 | 100 |
| Yeast for | 3 | 3 | 3 | 3 |
| frozen dough | | | | |
| Granulated | 15 | 15 | 15 | 15 |
| sugar | | | | |
| Salt | 1.5 | 1.5 | 1.5 | 1.5 |
| Skimmed | 2 | 2 | 2 | 2 |
| milk powder | | | | |
| Shortening | 12 | 12 | 12 | 12 |
| Untreated | 3 | | | |
| vital gluten | | | | |
| Powder Q | | 3 | | |
| (50° C.) | | | | |
| Powder R | | | 3 | |
| (60° C.) | | | | |
| Powder S | | | | 3 |
| (70° C.) | | | | |
| Water | 60 | 60 | 60 | 60 |

(3) Evaluation Method

The roll bread manufactured in (2) was subjected to the appearance observation and the specific volume, height, and firmness of the bread were measured in the same manner as in Example 1.

(4) Evaluation Result

The results on appearance observation are illustrated in FIG. 5, and the measurement results for the specific volume, height, and firmness of the bread are presented in the following Table 12.

TABLE 12

| | | Com- | Com- | Com- | |
|---|---|---|---|---|---|
| | | parative | parative | parative | Invention |
| | Period of | Product 5 | Product Q | Product R | Product S |
| | deep freeze | section | section | section | section |
| Specific | For 1 day | 5.56 | 6.03 | 5.78 | 6.14 |
| volume | For 7 days | 4.64 | 4.65 | 4.70 | 4.99 |
| (mug) | For 14 days | 4.43 | 4.60 | 4.59 | 4.68 |
| | For 30 days | 4.19 | 4.23 | 4.16 | 4.58 |
| Height | For 1 day | 37.9 | 38.3 | 37.2 | 42.3 |
| (mm) | For 7 days | 33.7 | 34.0 | 33.8 | 37.7 |
| | For 14 days | 32.8 | 33.6 | 32.7 | 37.2 |
| | For 30 days | 33.0 | 32.2 | 31.9 | 36.7 |
| Firm- | For 1 day | 0.37 | 0.45 | 0.45 | 0.52 |
| ness | For 7 days | 0.29 | 0.32 | 0.31 | 0.40 |
| | For 14 days | 0.24 | 0.25 | 0.27 | 0.36 |
| | For 30 days | 0.23 | 0.24 | 0.25 | 0.40 |

As presented in Table 12, in Comparative Products Q and R sections in which Powder Q (gluten treated with succinic acid at 50° C.) and Powder R (gluten treated with succinic acid at 60° C.) were respectively used, no difference was found as compared with Comparative Product 5 section in which untreated vital gluten was used. On the other hand, in Invention Product S section in which Powder S (gluten treated with succinic acid at 70° C.) was used, all of the specific volume, height, and firmness of the roll bread after being baked had higher values than those of Comparative Product 5 section in which untreated vital gluten was used. In addition, the high values were continuously kept even after 30 days of deep freeze in the case of using Powder S. In addition, as illustrated in FIG. 5, the roll bread had a shape with favorable firmness in the case of using Powder S. From the above results, it has been found that gluten treated with an organic acid (succinic acid), which is obtained by reacting gluten with an organic acid (succinic acid) at 50° C. to 60° C., does not have a sufficient effect of imparting freezing tolerance to a bread dough.

### (Example 6) Investigation on Reaction Time (1)

(1) Preparation of Sample

To 500 mL of distilled water, 4.00 g (0.034 mol) of succinic acid was added and mixed to obtain a mixed solution. To the mixed solution obtained, 100 g of vital gluten (water content: 5.8 W/W %) was added, and the mixture was heated to 80° C. by using a water bath while being sufficiently stirred. After the temperature reached to 80° C., stirring was further performed for 30 minutes to react the vital gluten with succinic acid. The reaction solution obtained was emulsified for 120 seconds by using a homogenizer. The emulsified solution was spread on a vat and dried by using a freeze dryer to obtain a dried product (water content: 4.8 W/W %). The dried product was pulverized by using a food processor, thereby obtaining Powder T.

Powder U was obtained in the same manner except that the reaction time was changed from 30 minutes to 60 minutes. In addition, Powder V was obtained in the same manner except that the reaction time was changed from 30 minutes to 300 minutes.

(2) Preparation of Bread Dough and Bread Making

Bread doughs were prepared and roll bread of each test section (Invention Product T section, Invention Product U section, Invention Product V section, and Comparative Product 6 section) was manufactured in the same manner as in Example 1 except that Powder T (gluten treated with succinic acid at 80° C. for 30 minutes), Powder U (gluten treated with succinic acid at 80° C. for 60 minutes) or Powder V (gluten treated with succinic acid at 80° C. for 300 minutes) prepared in (1) or untreated vital gluten was used and the respective raw materials were mixed so that the blending amounts presented in the following Table 13 were obtained.

TABLE 13

| | Comparative | Invention | Invention | Invention |
|---|---|---|---|---|
| | Product 6 | Product T | Product U | Product V |
| Strong flour | 100 | 100 | 100 | 100 |
| Yeast for frozen dough | 3 | 3 | 3 | 3 |
| Granulated sugar | 15 | 15 | 15 | 15 |
| Salt | 1.5 | 1.5 | 1.5 | 1.5 |
| Skimmed milk powder | 2 | 2 | 2 | 2 |
| Shortening | 12 | 12 | 12 | 12 |
| Untreated vital gluten | 3 | | | |
| Powder T (at 80° C. for 30 minutes) | | 3 | | |
| Powder U (at 80° C. for 60 minutes) | | | 3 | |
| Powder V (at 80° C. for 300 minutes) | | | | 3 |
| Water | 30 | 30 | 30 | 30 |

(3) Evaluation Method

The roll bread manufactured in (2) was subjected to the appearance observation and the specific volume, height, and firmness of the bread were measured in the same manner as in Example 1.

(4) Evaluation Result

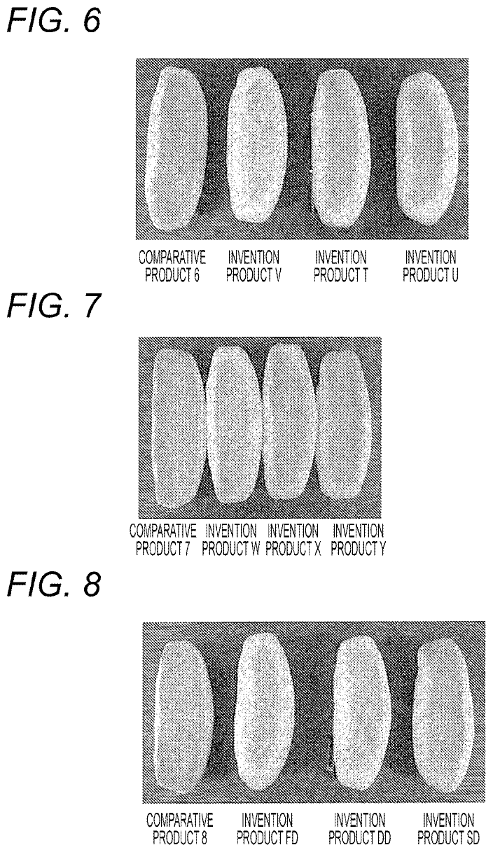

The results on appearance observation are illustrated in FIG. 6, and the measurement results for the specific volume, height, and firmness of the bread are presented in the following Table 14.

TABLE 14

| | | Comparative | Invention | Invention | Invention |
|---|---|---|---|---|---|
| | Period of | Product 6 | Product T | Product U | Product V |
| | deep freeze | section | section | section | section |
| Specific | For 1 day | 5.15 | 5.99 | 6.09 | 6.22 |
| volume | For 7 days | 5.00 | 5.73 | 5.61 | 5.74 |
| (mL/g) | For 14 days | 5.21 | 5.68 | 5.80 | 6.03 |
| Height | For 1 day | 38.0 | 40.6 | 41.8 | 42.8 |
| (mm) | For 7 days | 37.3 | 42.1 | 39.5 | 41.2 |
| | For 14 days | 37.6 | 39.9 | 41.3 | 41.8 |
| Firm- | For 1 day | 0.41 | 0.46 | 0.50 | 0.51 |
| ness | For 7 days | 0.37 | 0.54 | 0.44 | 0.47 |
| | For 14 days | 0.39 | 0.44 | 0.47 | 0.52 |

As presented in Table 14, in Invention Products T to V sections in which Powder T (gluten treated with succinic acid at 80° C. for 30 minutes), Powder U (gluten treated with succinic acid at 80° C. for 60 minutes), and Powder V (gluten treated with succinic acid at 80° C. for 300 minutes) were respectively used, all of the specific volume, height, and firmness of the roll bread after being baked had higher values than those of Comparative Product 6 section in which untreated vital gluten was used. In addition, the high values were continuously kept even after 30 days of deep freeze in the case of using Powders T to V. In addition, as illustrated in FIG. 6, the roll bread had a shape with favorable firmness in the case of using Powders T to V. From the above results, it has been found that gluten treated with an organic acid (succinic acid), which is obtained by reacting gluten with an organic acid (succinic acid) at 80° C. for 30 to 300 minutes, has an effect of imparting excellent freezing tolerance to a bread dough.

### (Example 7) Investigation on Reaction Time (2)

(1) Preparation of Sample

To 500 mL of distilled water, 4.00 g (0.034 mol) of succinic acid was added and mixed to obtain a mixed solution. To the mixed solution obtained, 100 g of vital gluten (water content: 5.8 W/W %) was added, and the mixture was heated to 70° C. by using a water bath while being sufficiently stirred. After the temperature reached to 70° C., stirring was further performed for 90 minutes to react the vital gluten with succinic acid. The reaction solution obtained was emulsified for 120 seconds by using a homogenizer. The emulsified reaction solution was spread on a vat and dried by using a freeze dryer to obtain a dried product (water content: 5.2 W/W %). The dried product was pulverized by using a food processor, thereby obtaining Powder W.

Powder X was obtained in the same manner except that the reaction time was changed from 90 minutes to 180 minutes. In addition, Powder Y was obtained in the same manner except that the reaction time was changed from 90 minutes to 300 minutes.

(2) Preparation of Bread Dough and Bread Making

Bread doughs were prepared and roll bread of each test section (Invention Product W section, Invention Product X section, Invention Product Y section, and Comparative Product 7 section) was manufactured in the same manner as in Example 1 except that Powder W (gluten treated with succinic acid at 70° C. for 90 minutes), Powder X (gluten treated with succinic acid at 70° C. for 180 minutes) or Powder Y (gluten treated with succinic acid at 70° C. for 300 minutes) prepared in (1) or untreated vital gluten was used and the respective raw materials were mixed so that the blending amounts presented in the following Table 15 were obtained.

TABLE 15

| | Comparative | Invention | Invention | Invention |
|---|---|---|---|---|
| | Product 7 | Product W | Product X | Product Y |
| Strong flour | 100 | 100 | 100 | 100 |
| Yeast for frozen dough | 3 | 3 | 3 | 3 |
| Granulated sugar | 15 | 15 | 15 | 15 |
| Salt | 1.5 | 1.5 | 1.5 | 1.5 |
| Skimmed milk powder | 2 | 2 | 2 | 2 |
| Shortening | 12 | 12 | 12 | 12 |
| Untreated vital gluten | 3 | | | |
| Powder W (at 70° C. for 90 minutes) | | 3 | | |
| Powder X (at 70° C. for 180 minutes) | | | 3 | |
| Powder Y (at 70° C. for 300 minutes) | | | | 3 |
| Water | 60 | 60 | 60 | 60 |

(3) Evaluation Method

The roll bread manufactured in (2) was subjected to the appearance observation and the specific volume, height, and firmness of the bread were measured in the same manner as in Example 1.

(4) Evaluation Result

The results on appearance observation are illustrated in FIG. 7, and the measurement results for the specific volume, height, and firmness of the bread are presented in the following Table 16.

TABLE 16

| | Period | Comparative | Invention | Invention | Invention |
|---|---|---|---|---|---|
| | of deep | Product 7 | Product W | Product X | Product Y |
| | freeze | section | section | section | section |
| Specific | For 1 day | 5.72 | 6.29 | 5.95 | 6.16 |
| volume | For 7 days | 4.66 | 5.11 | 4.84 | 4.92 |
| (mL/g) | For 14 days | 4.18 | 4.89 | 4.72 | 4.86 |
| | For 30 days | 4.34 | 4.69 | 4.81 | 4.76 |
| Height | For 1 day | 37.3 | 40.3 | 39.7 | 41.9 |
| (mm) | For 7 days | 32.3 | 35.9 | 35.9 | 37.9 |
| | For 14 days | 32.4 | 36.5 | 36.3 | 38.1 |
| | For 30 days | 31.1 | 34.5 | 35.0 | 36.7 |
| Firmness | For 1 day | 0.38 | 0.42 | 0.44 | 0.47 |
| | For 7 days | 0.25 | 0.36 | 0.36 | 0.43 |
| | For 14 days | 0.25 | 0.34 | 0.34 | 0.41 |
| | For 30 days | 0.20 | 0.34 | 0.27 | 0.40 |

As presented in Table 16, in Invention Products W to Y sections in which Powder W (gluten treated with succinic acid at 70° C. for 90 minutes), Powder X (gluten treated with succinic acid at 70° C. for 180 minutes), and Powder Y (gluten treated with succinic acid at 70° C. for 300 minutes) were respectively used, all of the specific volume, height, and firmness of the roll bread after being baked had higher values than those of Comparative Product 7 section in which untreated vital gluten was used. In addition, the high values were continuously kept even after 30 days of deep freeze in the case of using Powders W to Y. In particular, those obtained using Powder Y had high values in firmness and specific volume. In addition, as illustrated in FIG. 7, the roll bread had a shape with favorable firmness in the case of using Powders W to Y. From the above results, it has been found that gluten treated with an organic acid (succinic acid), which is obtained by reacting gluten with an organic acid (succinic acid) at 70° C. for 90 to 300 minutes, has an effect of imparting excellent freezing tolerance to a bread dough.

### (Example 8) Investigation on Drying Method

(1) Preparation of Sample

In a 30 L jar fermentor, 100 g (0.847 mol) of succinic acid was added to and mixed with 12.5 L of distilled water to obtain a mixed solution. To the mixed solution obtained, 2500 g of vital gluten (water content: 5.8 W/W %) was added, and the mixture was heated to 80° C. by jacket heating using steam while being sufficiently stirred. After the temperature reached to 80° C., stirring was further performed for 210 minutes to react the vital gluten with succinic acid. The reaction solution obtained was emulsified for 120 seconds by using a homogenizer. The emulsified solution was spread on a vat and dried by using a freeze dryer to obtain a dried product (water content: 4.8 W/W %). The dried product was pulverized by using a food processor, thereby obtaining a freeze-dried powder (Powder FD).

In a 30 L jar fermentor, 100 g (0.847 mol) of succinic acid was added to and mixed with 12.5 L of distilled water to obtain a mixed solution. To the mixed solution obtained, 2500 g of vital gluten (water content: 5.8 W/W %) was added, and the mixture was heated to 80° C. by jacket heating using steam while being sufficiently stirred. After the temperature reached to 80° C., stirring was further performed for 210 minutes to react the vital gluten with succinic acid. The reaction solution obtained was dried and powdered by using a double drum type drum dryer, thereby obtaining a drum-dried powder (Powder DD).

To 1000 mL of distilled water, 8 g (0.068 mol) of succinic acid and 2 g of salt were added and mixed to obtain a mixed solution. To the mixed solution obtained, 200 g of vital gluten (water content: 5.8 W/W %) was added, and the mixture was heated to 80° C. by using a water bath while being sufficiently stirred. After the temperature reached to 80° C., stirring was further performed for 300 minutes to react the vital gluten with succinic acid. Distilled water was added to the reaction solution obtained in a weight to be 1.5 times the weight of the reaction solution, and the emulsification treatment was performed for 120 seconds by using a homogenizer. The emulsified solution was spray-dried, thereby obtaining a spray-dried powder (Powder SD: water content of 4.6 W/W %).

(2) Preparation of Bread Dough and Bread Making

Bread doughs were prepared and roll bread of each test section (Invention Product FD section, Invention Product DD section, Invention Product SD section, and Comparative Product 8 section) was manufactured in the same manner as in Example 1 except that Powder FD, Powder DD or Powder SD prepared in (1) or untreated vital gluten was used and the respective raw materials were mixed so that the blending amounts presented in the following Table 17 were obtained.

TABLE 17

| | Comparative | Invention | Invention | Invention |
|---|---|---|---|---|
| | Product 8 | Product FD | Product DD | Product SD |
| Strong flour | 100 | 100 | 100 | 100 |
| Yeast for frozen | 3 | 3 | 3 | 3 |
| dough | | | | |
| Granulated sugar | 15 | 15 | 15 | 15 |
| Salt | 1.5 | 1.5 | 1.5 | 1.5 |
| Skimmed milk | 2 | 2 | 2 | 2 |
| powder | | | | |
| Shortening | 12 | 12 | 12 | 12 |
| Untreated vital | 3 | | | |
| gluten | | | | |
| Powder FD | | 3 | | |
| Powder DD | | | 3 | |
| Powder SD | | | | 3 |
| Water | 60 | 60 | 60 | 60 |

(3) Evaluation Method

The roll bread manufactured in (2) was subjected to the appearance observation and the specific volume, height, and firmness of the bread were measured in the same manner as in Example 1.

(4) Evaluation Result

The results on appearance observation are illustrated in FIG. 8, and the measurement results for the specific volume, height, and firmness of the bread are presented in the following Table 18.

TABLE 18

| | Period | Comparative | Invention | Invention | Invention |
|---|---|---|---|---|---|
| | of deep | Product 8 | Product FD | Product DD | Product SD |
| | freeze | section | section | section | section |
| Specific volume | For 1 day | 5.44 | 6.08 | 5.56 | 5.49 |
| (mL/g) | For 7 days | 4.78 | 5.50 | 5.42 | 5.35 |
| | For 14 days | 5.22 | 5.76 | 5.52 | 5.46 |
| | For 30 days | 4.73 | 5.29 | 5.22 | 5.19 |
| Height (mm) | For 1 day | 37.3 | 42.7 | 40.7 | 41.6 |
| | For 7 days | 36.2 | 41.9 | 39.5 | 41.5 |
| | For 14 days | 36.6 | 40.9 | 40.0 | 41.2 |
| | For 30 days | 35.9 | 40.8 | 39.5 | 41.4 |
| Firmness | For 1 day | 0.35 | 0.45 | 0.45 | 0.49 |
| | For 7 days | 0.29 | 0.47 | 0.39 | 0.47 |
| | For 14 days | 0.30 | 0.46 | 0.40 | 0.48 |
| | For 30 days | 0.31 | 0.50 | 0.44 | 0.46 |

As presented in Table 18, in Invention Products FD, DD, and SD sections in which Powder FD (freeze drying), Powder DD (drum drying), and Powder SD (spray drying) were respectively used, all of the specific volume, height, and firmness of the roll bread after being baked had higher values than those of Comparative Product 8 section in which untreated vital gluten was used. In addition, as illustrated in FIG. 8, the roll bread had a shape with favorable firmness in the case of using Powders FD, DD, and SD. From the above results, it has been found that the effect of imparting freezing tolerance by gluten treated with an organic acid (succinic acid) is obtained regardless of the drying method.

### (Example 9) Change in Amount of Water Added

(1) Preparation of Bread Dough and Bread Making

Bread doughs were prepared and roll bread of each test section (Invention Product FD65 section, Invention Product FD70 section, Invention Product FD75 section, Comparative Product 9A section, Comparative Product 9B section, and Comparative Product 9C section) was manufactured in the same manner as in Example 1 except that Powder FD prepared in Example 8 or untreated vital gluten was used and the respective raw materials were mixed so that the blending amounts (change in amount of water added) presented in the following Table 19 were obtained.

TABLE 19

| | | | | Invention | Invention | Invention |
|---|---|---|---|---|---|---|
| | Comparative | Comparative | Comparative | Product | Product | Product |
| | Product 9A | Product 9B | Product 9C | FD65 | FD70 | FD75 |
| Strong flour | 100 | 100 | 100 | 100 | 100 | 100 |
| Yeast for frozen dough | 3 | 3 | 3 | 3 | 3 | 3 |
| Granulated sugar | 15 | 15 | 15 | 15 | 15 | 15 |
| Salt | 1.5 | 1.5 | 1.5 | 1.5 | 1.5 | 1.5 |
| Skimmed milk powder | 2 | 2 | 2 | 2 | 2 | 2 |
| Shortening | 12 | 12 | 12 | 12 | 12 | 12 |
| Untreated vital gluten | 3 | 3 | 3 | | | |
| Powder FD | | | | 3 | 3 | 3 |
| Water | 65 | 70 | 75 | 65 | 70 | 75 |

(2) Evaluation Method

The roll bread manufactured in (1) was subjected to the appearance observation and the specific volume, height, and firmness of the bread were measured in the same manner as in Example 1.

(3) Evaluation Result

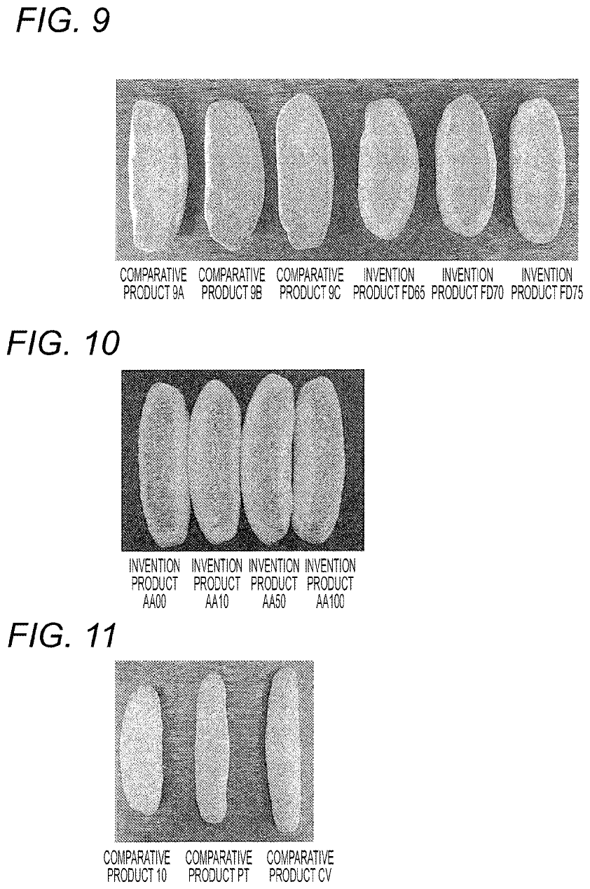

The results on appearance observation are illustrated in FIG. 9, and the measurement results for the specific volume, height, and firmness of the bread are presented in the following Table 20.

TABLE 20

| | | | | | Invention | Invention | Invention |
|---|---|---|---|---|---|---|---|
| | | Comparative | Comparative | Comparative | Product | Product | Product |
| | Period of | Product 9A | Product 9B | Product 9C | FD65 | FD70 | FD75 |
| | deep freeze | section | section | section | section | section | section |
| Specific | For 1 day | 5.40 | 5.61 | 5.44 | 5.88 | 6.11 | 6.02 |
| volume | For 7 days | 5.36 | 5.65 | 5.61 | 6.16 | 6.53 | 6.21 |
| (mL/g) | For 14 days | 5.01 | 4.97 | 5.11 | 5.53 | 5.44 | 5.49 |
| | For 30 days | 5.06 | 4.89 | 5.21 | 5.66 | 5.62 | 5.56 |
| Height | For 1 day | 36.5 | 35.3 | 35.0 | 41.2 | 39.8 | 38.7 |
| (mm) | For 7 days | 35.6 | 33.0 | 31.7 | 40.8 | 40.4 | 37.4 |
| | For 14 days | 34.3 | 32.6 | 32.3 | 40.0 | 38.9 | 37.3 |
| | For 30 days | 34.5 | 31.0 | 32.1 | 40.6 | 39.4 | 36.9 |
| Firmness | For 1 day | 0.31 | 0.23 | 0.20 | 0.47 | 0.40 | 0.41 |
| | For 7 days | 0.27 | 0.18 | 0.17 | 0.45 | 0.41 | 0.36 |
| | For 14 days | 0.25 | 0.14 | 0.18 | 0.41 | 0.33 | 0.31 |
| | For 30 days | 0.23 | 0.17 | 0.16 | 0.44 | 0.40 | 0.25 |

As presented in Table 20, in Invention Products FD65, FD70, and FD75 sections in which Powder FD (gluten treated with succinic acid) was used, all of the specific volume, height, and firmness of the roll bread after being baked had higher values than those of Comparative Products 9A, 9B, and 9C sections in which untreated vital gluten was used. In addition, the high values were continuously kept even after 30 days of deep freeze in the case of using Powder FD. In addition, as illustrated in FIG. 9, the roll bread had a shape with favorable firmness in the case of using Powder FD. From the above results, it has been found that the effect of imparting freezing tolerance by gluten treated with an organic acid (succinic acid) is obtained even when the amount of water added is increased.

### (Example 10) Influence of Concurrent Use with L-Ascorbic Acid

(1) Preparation of Bread Dough and Bread Making

Bread doughs were prepared and roll bread of each test section (Invention Product AA00 section, Invention Product AA10 section, Invention Product AA50 section, and Invention Product AA100 section) was manufactured in the same manner as in Example 1 except that Powder FD prepared in Example 8 was used and the respective raw materials were mixed so that the blending amounts (change in amount of L-ascorbic acid) presented in the following Table 21 were obtained.

TABLE 21

| | Invention | Invention | Invention | Invention |
|---|---|---|---|---|
| | Product | Product | Product | Product |
| | AA00 | AA10 | AA50 | AA100 |
| Strong flour | 100 | 100 | 100 | 100 |
| Yeast for frozen dough | 3 | 3 | 3 | 3 |
| Granulated sugar | 15 | 15 | 15 | 15 |
| Salt | 1.5 | 1.5 | 1.5 | 1.5 |
| Skimmed milk powder | 2 | 2 | 2 | 2 |
| Shortening | 12 | 12 | 12 | 12 |
| Powder FD | 2 | 2 | 2 | 2 |
| L-ascorbic acid | | 0.001 | 0.005 | 0.01 |
| Water | 60 | 60 | 60 | 60 |

(2) Evaluation Method

The roll bread manufactured in (1) was subjected to the appearance observation and the specific volume, height, and firmness of the bread were measured in the same manner as in Example 1.

(3) Evaluation Result

The results on appearance observation are illustrated in FIG. 10, and the measurement results for the specific volume, height, and firmness of the bread are presented in the following Table 22.

TABLE 22

| | Period | Invention | Invention | Invention | Invention |
|---|---|---|---|---|---|
| | of deep | Product AA00 | Product AA10 | Product AA50 | Product AA100 |
| | freeze | section | section | section | section |
| Specific | For 1 day | 5.26 | 5.25 | 5.41 | 5.59 |
| volume | For 7 days | 5.13 | 5.17 | 5.31 | 5.27 |
| (mL/g) | For 14 days | 5.10 | 4.93 | 5.25 | 5.10 |
| | For 30 days | 4.98 | 4.92 | 5.20 | 5.23 |
| Height mm) | For 1 day | 40.6 | 40.6 | 41.0 | 40.3 |
| | For 7 days | 39.2 | 39.3 | 39.1 | 39.4 |
| | For 14 days | 38.1 | 38.5 | 38.8 | 39.1 |
| | For 30 days | 38.6 | 37.8 | 38.9 | 39.8 |
| Firmness | For 1 day | 0.52 | 0.53 | 0.55 | 0.53 |
| | For 7 days | 0.47 | 0.50 | 0.49 | 0.51 |
| | For 14 days | 0.46 | 0.45 | 0.47 | 0.46 |
| | For 30 days | 0.43 | 0.43 | 0.47 | 0.45 |

As presented in Table 22, all of the specific volume, height, and firmness of the roll bread after being baked had high values even in the case of decreasing the amount of L-ascorbic acid added since Powder FD (gluten treated with succinic acid) was used. In addition, the high values were continuously kept even after 30 days of deep freeze. In addition, as illustrated in FIG. 10, the roll bread had a shape with favorable firmness regardless of the amount of L-ascorbic acid added in the case of using Powder FD (gluten treated with succinic acid). From the above results, it has been found that the effect of imparting freezing tolerance by gluten treated with an organic acid (succinic acid) is obtained even when the amount of L-ascorbic acid added is decreased.

### (Example 11) Investigation on Kind of Dough

(1) Preparation of Bread Dough and Bread Making

In the blending amounts presented in the following Table 23, the raw materials (wheat flour (strong flour), yeast for scratch dough, aqueous solution of L-ascorbic acid (an aqueous solution prepared by adding 1 g of L-ascorbic acid to 100 mL of water), granulated sugar, salt, skimmed milk powder, and water) were mixed with Powder FD (gluten treated with succinic acid) prepared in Example 8 for Invention Product FD001 and untreated vital gluten for Comparative Product 001, respectively.

TABLE 23

| | Additive-free | Comparative | Invention |
|---|---|---|---|
| | Product 002 | Product 001 | Product FD001 |
| Strong flour | 100 | 100 | 100 |
| Yeast | 3 | 3 | 3 |
| Aqueous solution of | 0.1 | 0.1 | 0.1 |
| L-ascorbic acid | | | |
| Granulated sugar | 15 | 15 | 15 |
| Salt | 1.5 | 1.5 | 1.5 |
| Skimmed milk powder | 2 | 2 | 2 |
| Shortening | 12 | 12 | 12 |
| Untreated vital gluten | | 3 | |
| Powder FD | | | 3 |
| Water | 58 | 61 | 61 |

The mixed raw materials were mixed at a low speed for 3 minutes, at a medium speed for 2 minutes, and at a high speed for 2 minutes. After the addition of shortening, the mixture was further mixed at a low speed for 2 minutes, at a medium speed for 3 minutes, and at a high speed for 3 minutes, thereby obtaining a mainly mixed dough. Incidentally, the mixing was adjusted so that the final dough temperature was 27° C. After taking the floor time at 28° C. for 60 minutes, the mainly mixed dough was divided into small doughs so that each had a weight of 50 g, and the small doughs took the bench time for 20 minutes and each were subjected to roll molding using a molder. Thereafter, the final fermentation thereof was performed for 60 minutes under the conditions of 38° C. and a humidity of 85%, and the doughs fermented were baked for 8 minutes in an oven (upper fire: 210° C. and lower fire: 190° C.), thereby manufacturing roll bread of each test section (Additive-free Product 002 section, Comparative Product 001 section, and Invention Product FD001 section).

(2) Evaluation Method

The roll bread manufactured in (1) was subjected to the appearance observation and the specific volume, height, and firmness of the bread were measured in the same manner as in Example 1.

(3) Evaluation Result

The measurement results for the specific volume, height, and firmness of the bread are presented in the following Table 24.

TABLE 24

| | Additive-free | Comparative | Invention |
|---|---|---|---|
| | Product 002 | Product 001 | Product FD001 |
| | section | section | section |
| Specific volume | 6.24 | 6.30 | 6.40 |
| (mL/g) | | | |
| Height mm) | 43.6 | 44.3 | 43.7 |
| Firmness | 0.46 | 0.47 | 0.50 |

As presented in Table 24, in Invention Product FD001 section in which Powder FD (gluten treated with succinic acid) was used, the firmness of the roll bread after being baked had a higher value than that of Comparative Product 001 section in which untreated vital gluten was used and Additive-free Product 002 section. It was possible to use gluten treated with an organic acid (succinic acid) not only in a frozen dough but also in a dough for the scratch method. In addition, it is also indicated that it is possible to simultaneously manufacture a dough for the scratch method and a frozen dough from the same dough by using gluten treated with an organic acid.

(Comparative Test 1) Comparative Test Using Gluten Treated with Amine

(1) Preparation of Sample

Comparative Powder PT was prepared in the same manner as in Example 1 except that 4.0 g of succinic acid was changed to 9.0 g of putrescine. In addition, Comparative Powder CV was prepared in the same manner as in Example 1 except that 4.0 g of succinic acid was changed to 10.9 g of cadaverine.

(2) Preparation of Bread Dough and Bread Making

Bread doughs were prepared and roll bread of each test section (Comparative Product PT section, Comparative Product CV section, and Comparative Product 10 section) was manufactured in the same manner as in Example 1 except that Comparative Powder PT (gluten treated with putrescine) or Comparative Powder CV (gluten treated with cadaverine) prepared in (1) or untreated vital gluten was used and the respective raw materials were mixed so that the blending amounts presented in the following Table 25 were obtained.

TABLE 25

| | Comparative | Comparative | Comparative |
|---|---|---|---|
| | Product 10 | Product PT | Product CV |
| Strong flour | 100 | 100 | 100 |
| Yeast for frozen dough | 3 | 3 | 3 |
| Granulated sugar | 15 | 15 | 15 |
| Salt | 1.5 | 1.5 | 1.5 |
| Skimmed milk powder | 2 | 2 | 2 |
| Shortening | 12 | 12 | 12 |
| Untreated vital gluten | 3 | | |
| Comparative Powder PT | | 3 | |
| Comparative Powder CV | | | 3 |
| Water | 60 | 60 | 60 |

(3) Evaluation Method

The roll bread manufactured in (2) was subjected to the appearance observation and the specific volume, height, and firmness of the bread were measured in the same manner as in Example 1.

(4) Evaluation Result

The results on appearance observation are illustrated in FIG. 11, and the measurement results for the specific volume, height, and firmness of the bread are presented in the following Table 26.

TABLE 26

| | Period | Comparative | Comparative | Comparative |
|---|---|---|---|---|
| | of deep | Product | Product | Product |
| | freeze | 10 section | PT section | CV section |
| Specific | For 1 day | 5.74 | 3.96 | 4.01 |
| volume | For 7 days | 4.99 | 4.01 | 4.11 |
| (mL/g) | For 14 days | 4.76 | 4.20 | 4.14 |
| | For 30 days | 4.28 | 3.80 | 3.96 |
| Height mm) | For 1 day | 39.6 | 31.2 | 29.0 |
| | For 7 days | 37.7 | 31.3 | 28.8 |
| | For 14 days | 36.1 | 31.1 | 27.3 |
| | For 30 days | 35.3 | 30.9 | 27.5 |
| Firmness | For 1 day | 0.40 | 0.42 | 0.36 |
| | For 7 days | 0.34 | 0.38 | 0.31 |
| | For 14 days | 0.35 | 0.38 | 0.29 |
| | For 30 days | 0.26 | 0.37 | 0.26 |

As is apparent from the appearance illustrated in FIG. 11, fermentation failure occurred in Comparative Product PT section and Comparative Product CV section in which Comparative Powder PT (gluten treated with putrescine) and Comparative Powder CV (gluten treated with cadaverine) were used, respectively. As presented in Table 24, in Comparative Product PT section and Comparative Product CV section in which Comparative Powder PT (gluten treated with putrescine) and Comparative Powder CV (gluten treated with cadaverine) were respectively used, the specific volume and height of the roll bread after being baked were clearly inferior even in the case of being compared with Comparative Product 10 section in which untreated vital gluten was used.

(Comparative Test 2) Comparative Test by Change in pH

(1) Preparation of Sample

A reaction solution (pH: 3.3) was obtained in the same manner as in Example 1 except that 4.0 g of succinic acid was changed to 10.0 g of acetic acid, and then the emulsification and drying treatments were performed, thereby preparing Comparative Powder SA. In addition, a reaction solution (pH: 3.14) was obtained in the same manner as in Example 1 except that 12 N hydrochloric acid was used instead of 4.0 g of succinic acid to adjust the pH of the aqueous solution to pH 3.5, and then the emulsification and drying treatments were performed, thereby preparing Comparative Powder HA.

(2) Preparation of Bread Dough and Bread Making

Bread doughs were prepared and roll bread of each test section (Comparative Product SA section, Comparative Product HA section, and Comparative Product 11 section) was manufactured in the same manner as in Example 1 except that Comparative Powder SA (gluten treated with acetic acid) or Comparative Powder HA (gluten treated with hydrochloric acid) prepared in (1) or untreated vital gluten was used and the respective raw materials were mixed so that the blending amounts presented in the following Table 27 were obtained.

TABLE 27

| | Comparative | Comparative | Comparative |
|---|---|---|---|
| | Product 11 | Product SA | Product HA |
| Strong flour | 100 | 100 | 100 |
| Yeast for frozen dough | 3 | 3 | 3 |
| Granulated sugar | 15 | 15 | 15 |
| Salt | 1.5 | 1.5 | 1.5 |
| Skimmed milk powder | 2 | 2 | 2 |
| Shortening | 12 | 12 | 12 |
| Untreated vital gluten | 3 | | |
| Comparative Powder SA | | 3 | |
| Comparative Powder HA | | | 3 |
| Water | 60 | 60 | 60 |

(3) Evaluation Method

The roll bread manufactured in (2) was subjected to the appearance observation and the specific volume, height, and firmness of the bread were measured in the same manner as in Example 1.

(4) Evaluation Result

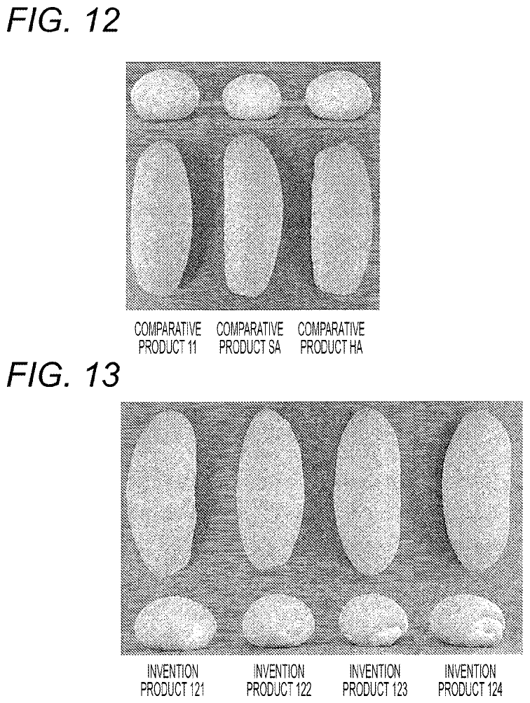

The results on appearance observation are illustrated in FIG. 12, and the measurement results for the specific volume, height, and firmness of the bread are presented in the following Table 28.

TABLE 28

| | Period | Comparative | Comparative | Comparative |
|---|---|---|---|---|
| | of deep | Product 11 | Product SA | Product HA |
| | freeze | section | section | section |
| Specific | For 1 day | 5.26 | 5.20 | 5.30 |
| volume | For 7 days | 4.93 | 4.99 | 4.92 |
| (mL/g) | For 14 days | 4.64 | 4.72 | 4.82 |
| | For 30 days | 4.67 | 4.70 | 4.80 |
| Height mm) | For 1 day | 41.7 | 40.0 | 39.8 |
| | For 7 days | 39.7 | 38.7 | 38.9 |
| | For 14 days | 37.8 | 37.6 | 38.3 |
| | For 30 days | 37.8 | 36.5 | 37.1 |
| Firmness | For 1 day | 0.45 | 0.43 | 0.39 |
| | For 7 days | 0.41 | 0.41 | 0.41 |
| | For 14 days | 0.41 | 0.40 | 0.40 |
| | For 30 days | 0.41 | 0.40 | 0.39 |

As presented in Table 28, in Comparative Product SA section and Comparative Product HA section in which Comparative Powder SA (gluten treated with acetic acid) and Comparative Powder HA (gluten treated with hydrochloric acid) were respectively used, no significant difference was found in any of the specific volume, height, and firmness of the roll bread after being baked as compared with Comparative Product 11 section in which untreated vital gluten was used. From the above results, it has been found that the effect of imparting freezing tolerance is not obtained by gluten treated with an organic acid which does not have two or more carbonyl groups or an inorganic acid.

### (Example 12) Investigation on Concurrent Use of Two or More Kinds of Organic Acids

(1) Preparation of Sample

To 500 g of distilled water, 100 g of vital gluten (water content: 5.8 W/W %) was added and dissolved, 4.00 g (0.034 mol) of succinic acid was added to the solution, and the mixture was heated to 80° C. by using a water bath while being sufficiently stirred. After the temperature reached to 80° C., stirring was further performed for 240 minutes to react the vital gluten with succinic acid. The reaction solution obtained was spread on a vat and dried by using a freeze dryer to obtain a dried product (water content: 5.5 W/W %). The dried product was pulverized by using a hammer mill, thereby obtaining Powder 121.

Powder 122 was obtained in the same manner except that 4.00 g of succinic acid was changed to 4.00 g of organic acids composed of 2.00 g of succinic acid and 2.00 g of citric acid.

In addition, Powder 123 was obtained in the same manner except that 4.00 g of succinic acid was changed to 4.00 g of organic acids composed of 2.00 g of succinic acid and 2.00 g of malic acid.

In addition, Powder 124 was obtained in the same manner except that 4.00 g of succinic acid was changed to 4.00 g of organic acids composed of 2.00 g of citric acid and 2.00 g of malic acid.

(2) Preparation of Bread Dough and Bread Making

In the blending amounts presented in the following Table 29, the raw materials (wheat flour (strong flour), yeast for frozen dough, granulated sugar, salt, skimmed milk powder, and water) were mixed with Powder 121 (gluten treated with 4.00 g of succinic acid) for Invention Product 121, Powder 122 (gluten treated with 2.00 g of succinic acid and 2.00 g of citric acid) for Invention Product 122, Powder 123 (gluten treated with 2.00 g of succinic acid and 2.00 g of malic acid) for Invention Product 123, and Powder 124 (gluten treated with 2.00 g of citric acid and 2.00 g of malic acid) for Invention Product 124, respectively.

TABLE 29

| | Invention | Invention | Invention | Invention |
|---|---|---|---|---|
| | Product | Product | Product | Product |
| | 121 | 122 | 123 | 124 |
| Strong flour | 100 | 100 | 100 | 100 |
| Yeast for frozen dough | 3 | 3 | 3 | 3 |
| Granulated sugar | 15 | 15 | 15 | 15 |
| Salt | 1.5 | 1.5 | 1.5 | 1.5 |
| Skimmed milk powder | 2 | 2 | 2 | 2 |
| Shortening | 12 | 12 | 12 | 12 |
| Powder 121 (gluten treated | 3 | | | |
| with 4.00 g of succinic acid) | | | | |
| Powder 122 (gluten treated | | 3 | | |
| with 2.00 g of succinic acid | | | | |
| and 2.00 g of citric acid) | | | | |
| Powder 123 (gluten treated | | | 3 | |
| with 2.00 g of succinic acid | | | | |
| and 2.00 g of malic acid) | | | | |
| Powder 124 (gluten treated | | | | 3 |
| with 2.00 g of citric acid | | | | |
| and 2.00 g of malic acid) | | | | |
| Water | 61 | 61 | 61 | 61 |

The mixed raw materials were mixed at a low speed for 3 minutes, at a medium speed for 2 minutes, and at a high speed for 2 minutes. After the addition of shortening, the mixture was further mixed at a low speed for 2 minutes, at a medium speed for 3 minutes, and at a high speed for 2 minutes, thereby obtaining a mainly mixed dough. Incidentally, the mixing was adjusted so that the final dough temperature was 24° C. After taking the floor time at 28° C. for 30 minutes, the mainly mixed dough was divided into small doughs so that each had a weight of 50 g, and the small doughs took the bench time for 20 minutes and each were subjected to roll molding using a molder. The roll-molded doughs were rapidly frozen at −35° C. for 60 minutes to obtain frozen doughs. The frozen doughs obtained were deep-frozen at −25° C. for a predetermined period of time. After deep freeze, the frozen doughs were allowed to still stand for 30 minutes under the conditions of 30° C. and a humidity of 65% to be thawed. After thawing, final fermentation was performed for 60 minutes under the conditions of 38° C. and a humidity of 85%. Thereafter, the doughs fermented were baked for 9 minutes in an oven (upper fire: 210° C. and lower fire: 200° C.), thereby manufacturing roll bread. Incidentally, six pieces of roll bread were manufactured for each test section.

(3) Evaluation Method

The roll bread manufactured in (2) was subjected to the appearance observation and the specific volume, height, and firmness of the bread were measured in the same manner as in Example 1.

(4) Evaluation Result

The results on appearance observation are illustrated in FIG. 13, and the measurement results for the specific volume, height, and firmness of the bread are presented in the following Table 30.

TABLE 30

| | Period | Invention | Invention | Invention | Invention |
|---|---|---|---|---|---|
| | of deep | Product 121 | Product 122 | Product 123 | Product 124 |
| | freeze | section | section | section | section |
| Specific volume | For 1 day | 5.79 | 5.80 | 5.88 | 5.87 |
| (mL/g) | For 7 days | 5.77 | 5.94 | 5.90 | 6.02 |
| | For 14 days | 5.83 | 5.86 | 5.83 | 5.84 |
| | For 30 days | 5.42 | 5.54 | 5.50 | 5.38 |
| Height mm) | For 1 day | 43.7 | 43.7 | 43.5 | 42.1 |
| | For 7 days | 42.5 | 42.5 | 44.2 | 41.8 |
| | For 14 days | 41.5 | 42.2 | 42.4 | 41.4 |
| | For 30 days | 41.5 | 41.8 | 41.7 | 41.0 |
| Firmness | For 1 day | 0.56 | 0.53 | 0.53 | 0.53 |
| | For 7 days | 0.52 | 0.49 | 0.52 | 0.50 |
| | For 14 days | 0.51 | 0.5 | 0.51 | 0.52 |
| | For 30 days | 0.53 | 0.51 | 0.5 | 0.48 |

As presented in Table 30, in Invention Product 121 to Invention Product 124 sections in which Powder 121 (gluten treated with 4.00 g of succinic acid), Powder 122 (gluten treated with 2.00 g of succinic acid and 2.00 g of citric acid), Powder 123 (gluten treated with 2.00 g of succinic acid and 2.00 g of malic acid), and Powder 124 (gluten treated with 2.00 g of citric acid and 2.00 g of malic acid) were respectively used, all of the specific volume, height, and firmness of the roll bread after being baked had high values. In addition, the high values were continuously kept even after 30 days of deep freeze. From the above results, it has been found that the effect of imparting freezing tolerance is obtained even in the case of mixing two kinds of organic acids having two or more carbonyl groups.

### (Example 13) Investigation on Amount of Organic Acid (2)

(1) Preparation of Sample

To 500 g of distilled water, 100 g of vital gluten (water content: 5.8 W/W %) was added and dissolved, 0.50 g (0.004 mol) of succinic acid was added to the solution, and the mixture was heated to 80° C. by using a water bath while being sufficiently stirred. After the temperature reached to 80° C., stirring was further performed for 240 minutes to react the vital gluten with succinic acid. The reaction solution obtained was spread on a vat and dried by using a freeze dryer to obtain a dried product (water content: 5.5 W/W %). The dried product was pulverized by using a hammer mill, thereby obtaining Powder 131.

Powder 132 was obtained in the same manner except that 0.50 g of succinic acid was changed to 1.00 g of succinic acid.

In addition, Powder 133 was obtained in the same manner except that 0.50 g of succinic acid was changed to 2.00 g of succinic acid.

(2) Preparation of Bread Dough and Bread Making

In the blending amounts presented in the following Table 31, the raw materials (wheat flour (strong flour), yeast for frozen dough, granulated sugar, salt, skimmed milk powder, and water) were mixed with vital gluten before being reacted for Comparative Product 130, Powder 131 (gluten treated with 0.50 g of succinic acid) for Comparative Product 131, Powder 132 (gluten treated with 1.00 g of succinic acid) for Invention Product 132, and Powder 133 (gluten treated with 2.00 g of succinic acid) for Invention Product 133, respectively.

TABLE 31

| | Comparative | Comparative | Invention | Invention |
|---|---|---|---|---|
| | Product 130 | Product 131 | Product 132 | Product 133 |
| Strong flour | 100 | 100 | 100 | 100 |
| Yeast for frozen dough | 3 | 3 | 3 | 3 |
| Granulated sugar | 15 | 15 | 15 | 15 |
| Salt | 1.5 | 1.5 | 1.5 | 1.5 |
| Skimmed milk powder | 2 | 2 | 2 | 2 |
| Shortening | 12 | 12 | 12 | 12 |
| Powder 131 (gluten treated | | 3 | | |
| with 0.50 g of succinic acid) | | | | |
| Powder 132 (gluten treated | | | 3 | |
| with 1.00 g of succinic acid) | | | | |
| Powder 133 (gluten treated | | | | 3 |
| with 2.00 g of succinic acid) | | | | |
| Vital gluten before being | 3 | | | |
| reacted | | | | |
| Water | 61 | 61 | 61 | 61 |

The mixed raw materials were mixed at a low speed for 3 minutes, at a medium speed for 2 minutes, and at a high speed for 2 minutes. After the addition of shortening, the mixture was further mixed at a low speed for 2 minutes, at a medium speed for 3 minutes, and at a high speed for 2 minutes, thereby obtaining a mainly mixed dough. Incidentally, the mixing was adjusted so that the final dough temperature was 24° C. After taking the floor time at 28° C. for 30 minutes, the mainly mixed dough was divided into small doughs so that each had a weight of 50 g, and the small doughs took the bench time for 20 minutes and each were subjected to roll molding using a molder. The roll-molded doughs were rapidly frozen at −35° C. for 60 minutes to obtain frozen doughs. The frozen doughs obtained were deep-frozen at −25° C. for a predetermined period of time. After deep freeze, the frozen doughs were allowed to still stand for 30 minutes under the conditions of 30° C. and a humidity of 65% to be thawed. After thawing, final fermentation was performed for 60 minutes under the conditions of 38° C. and a humidity of 85%. Thereafter, the doughs fermented were baked for 9 minutes in an oven (upper fire: 210° C. and lower fire: 200° C.), thereby manufacturing roll bread. Incidentally, six pieces of roll bread were manufactured for each test section.

(3) Evaluation Method

The roll bread manufactured in (2) was subjected to the appearance observation and the specific volume, height, and firmness of the bread were measured in the same manner as in Example 1.

(4) Evaluation Result

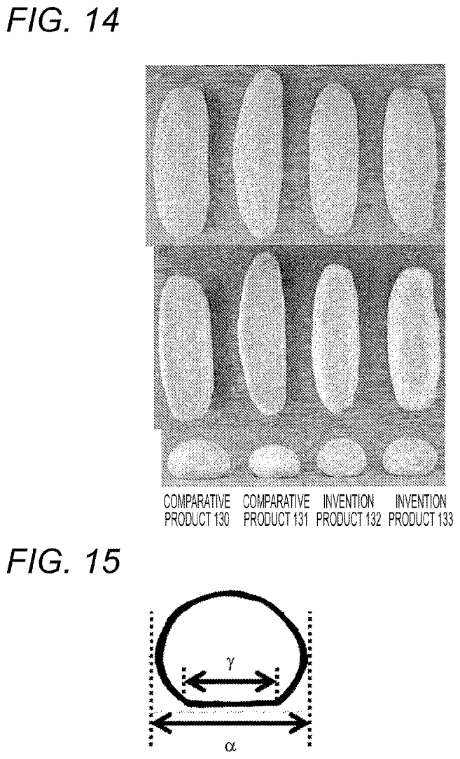

The results on appearance observation are illustrated in FIG. 14, and the measurement results for the specific volume, height, and firmness of the bread are presented in the following Table 32.

TABLE 32

| | Period | Comparative | Comparative | Invention | Invention |
|---|---|---|---|---|---|
| | of deep | Product 130 | Product 131 | Product 132 | Product 133 |
| | freeze | section | section | section | section |
| Specific volume | For 1 day | 5.28 | 4.51 | 4.87 | 5.23 |
| (mL/g) | For 7 days | 5.12 | 4.86 | 5.03 | 5.38 |
| | For 14 days | 4.66 | 4.28 | 4.72 | 4.86 |
| | For 30 days | 4.74 | 3.84 | 4.45 | 4.84 |
| Height (mm) | For 1 day | 37.6 | 34.2 | 39.4 | 40.1 |
| | For 7 days | 36.3 | 33.3 | 39.0 | 39.1 |
| | For 14 days | 36.5 | 33.8 | 38.7 | 40.3 |
| | For 30 days | 33.9 | 29.0 | 36.6 | 37.5 |
| Firmness | For 1 day | 0.44 | 0.34 | 0.48 | 0.50 |
| | For 7 days | 0.36 | 0.35 | 0.49 | 0.52 |
| | For 14 days | 0.38 | 0.31 | 0.47 | 0.49 |
| | For 30 days | 0.28 | 0.20 | 0.43 | 0.47 |

As presented in Table 32, in Comparative Product 130 section in which vital gluten before being reacted was used and Comparative Product 131 section in which Powder 131 (gluten treated with 0.50 g of succinic acid) was used, the height of the roll bread baked after deep freeze was not held and the firmness thereof was greatly decreased. In contrast, in Invention Product 132 and Invention Product 133 sections in which Powder 132 (gluten treated with 1.00 g of succinic acid) and Powder 133 (gluten treated with 2.00 g of succinic acid) were respectively used, all of the specific volume, height, and firmness of the roll bread after being baked had high values. In addition, the high values were continuously kept even after 30 days of deep freeze.

### INDUSTRIAL APPLICABILITY

The present invention can be utilized in a bread dough modifying agent and the field of bread manufacture.

All publications, patents and patent applications cited in this specification are incorporated herein by reference in their entirety.

1. A method for manufacturing a bread dough, the method comprising:
preparing a bread dough using modified gluten obtained by heating a solution containing gluten and an organic acid having two or more carbonyl groups in the same molecule at 1 part by weight or more per 100 parts by weight of the gluten at 70° C. or higher for 30 minutes or longer.

2. A method for manufacturing bread, the method comprising:
preparing a bread dough using modified gluten obtained by heating a solution containing gluten and an organic acid having two or more carbonyl groups in the same molecule at 1 part by weight or more per 100 parts by weight of the gluten at 70° C. or higher for 30 minutes or longer; and
baking the bread dough prepared.

3. A method for modifying physical properties of bread, the method comprising:
adding modified gluten obtained by heating a solution containing gluten and an organic acid having two or more carbonyl groups in the same molecule at 1 part by weight or more per 100 parts by weight of the gluten at 70° C. or higher for 30 minutes or longer to a raw material for bread dough.

4. The method according to claim 3, wherein modification in physical properties of bread comprises improvement in firmness of bread.

5. The method according to claim 3, wherein modification in physical properties of bread comprises improvement in appearance as determined by measuring specific volume of the bread, height of the bread, and firmness of bread after bread dough is subjected to freezing temperature and then baking.

6. The method according to claim 1, wherein the bread dough is a frozen bread dough.

7. The method according to claim 2, wherein the bread dough is a frozen bread dough.

8. The method according to claim 3, wherein the bread dough is a frozen bread dough.
